(19) United States
(12) Patent Application Publication
(10) Pub. No.: US 2012/0182416 A1
(43) Pub. Date: Jul. 19, 2012

(54) IMAGE PROJECTION SYSTEM AND SEMICONDUCTOR INTEGRATED CIRCUIT

(75) Inventor: Hirofumi KAWAGUCHI, Kanagawa (JP)

(73) Assignee: Renesas Electronics Corporation

(21) Appl. No.: 13/348,276

(22) Filed: Jan. 11, 2012

(30) Foreign Application Priority Data
Jan. 19, 2011 (JP) 2011-008927

(51) Int. Cl. G03B 21/14; H04N 7/18; G06K 9/40; G09G 5/00

(52) U.S. Cl. 348/128; 353/69; 345/647; 382/275; 348/E07.085

(57) ABSTRACT

An image projection system outputs an image from a lens and projects it onto a projection plane, and if resolution of the image projected onto the projection plane in each region is not uniform among respective regions, will correct resolutions of the respective regions of the image based on an inverse characteristic of the lens optical characteristic and will project the image onto the projection plane. Moreover, when the resolution of one region of the image falls lower than the resolutions of other regions by projecting the image onto the projection plane so that a shape of the image may not be distorted, the system projects an image whose resolution is deteriorated so that the resolutions of the other regions become substantially the same as the resolution of the one region.

### CROSS-REFERENCE TO RELATED APPLICATIONS

The disclosure of Japanese Patent Application No. 2011-8927 filed on Jan. 19, 2011 including the specification, drawings and abstract is incorporated herein by reference in its entirety.

### BACKGROUND

The present invention relates to an image projection system and a semiconductor integrated circuit therefor, and more specifically, to an image projection system for correcting and re-projecting an image projected onto a projection plane and a semiconductor integrate circuit therefor.

In recent years, a high pixel count (XGA to FHD resolution) and compact front projectors can be available at low prices. Furthermore, a model of the front projector with a 3D function has also appeared. Now, the front projectors are limited to neither theater purposes nor presentation purposes in offices, but have become to be used in various purposes and scenes. For example, in mobile products, there is a case where the front projector may be carried on a cellular phone as an additional function. Moreover, there is a case where the front projector may be utilized for interiors, goods for toys, or business purposes, such as digital signage. Furthermore, the front projector may find utilization fields in installation or art purposes of lighting etc.

Thus, the high pixel count and compact front projector has various purposes and scenes in which it can be used, and offers high convenience to customers. However, adjustment required to properly display a video on the projection plane still has high difficulty. In particular, in recent years, projection onto the projection plane having an uneven surface, a curved surface, or the like has come to be performed. However, although techniques of realizing the projection onto the uneven surface or the curved surface have been proposed, a quality of displayed image is low. Then, when using the technique, a planar and white screen is required in fact. Thus, many restrictions and obstacles exist in a use range of the front projector.

Here, as a method for adjusting the video displayed by the projector, generally, there is a method for adjusting a size and a focus parameter (diaphragm) optically by detecting a distance between the projector and the screen using an infrared sensor etc. Then, Japanese Patent Application Publication No. 2007-306613 discloses a method whereby a projection area is recognized by acquiring the screen projected image onto a dedicated screen with an image sensor and a size and a display position of the projection area is adjusted to the screen.

Moreover, regarding geometric distortion, it is generally performed to correct the distortion by means of mechanical lens shift or distortion of an electrical image processing by detecting an amount of tilt of the projector apparatus with an acceleration (tilt) sensor etc. Then, Japanese Patent Application Publication No. 2001-083949 discloses a method for correcting the geometric distortion by analyzing a difference between the test image projected onto the screen and an original test image with the image sensor.

Here, in Japanese Patent Application Publication No. 2010-171774, there is disclosed a technology related to a portable type image projection apparatus capable of projecting a suitable image onto an arbitrary projection plane regardless of a projection direction and unevenness of the projection plane. The technology pertaining to Japanese Patent Application Publication No. 2010-171774 is one that projects an image onto the projection plane, photographs the projected image appearing on the projection plane, and corrects the geometric distortion of the projected image for every predetermined divided region. Moreover, Japanese Patent Application Publication No. 2005-326247 discloses a technology about a calibrating apparatus for projecting a beautiful image regardless of a form of the projection plane and the like. Furthermore, Japanese Patent Application Publication No. 2006-033357 discloses a technology about an image conversion apparatus for correcting distortion of the video caused by distortion of the screen itself and the like.

Incidentally, Japanese Patent Application Publication No. 2006-201548 discloses a technology about an image projection apparatus and an image projecting method for correcting the image to have a right hue and making it unsusceptible to an influence of a pattern even when the projection plane has a coloring or a pattern. Moreover, Japanese Patent Application Publication No. 2006-109380 discloses a technology about a projected image adjusting method and a projector that can display colors of a color image with a good reproducibility on a body on which the image is projected and can make a user easily recognize a correction effect of hue of the body on which the image is projected. Moreover, Japanese Patent Application Publication No. 2004-229290 discloses a technology about a projection system for actively compensating a color characteristic of the projection plane. Moreover, Japanese Patent Application Publication No. 2010-212917 discloses a technology about a projector apparatus for making the projected image projected onto the projection plane easy to see without being influenced by a pattern and dirt of the projection plane.

### SUMMARY

The inventors of this application found out a next problem to the above-mentioned Japanese Patent Application Publication No. 2007-306613, Japanese Patent Application Publication No. 2001-083949, Japanese Patent Application Publication No. 2010-171774, Japanese Patent Application Publication No. 2005-326247, Japanese Patent Application Publication No. 2006-033357, Japanese Patent Application Publication No. 2006-201548, Japanese Patent Application Publication No. 2006-109380, Japanese Patent Application Publication No. 2004-229290, and Japanese Patent Application Publication No. 2010-212917. That is, image projection systems etc. according to the above-mentioned Japanese Patent Application Publication No. 2007-306613, Japanese Patent Application Publication No. 2001-083949, Japanese Patent Application Publication No. 2010-171774, Japanese Patent Application Publication No. 2005-326247, Japanese Patent Application Publication No. 2006-033357, Japanese Patent Application Publication No. 2006-201548, Japanese Patent Application Publication No. 2006-109380, Japanese Patent Application Publication No. 2004-229290, and Japanese Patent Application Publication No. 2010-212917 could not solve a subject at all that the resolution of the image being projected became ununiform within the image by an optical factor or electrical factor, and they equally involve a problem that image quality deterioration of the projected image on human visibility is made to occur. This application of the present invention is one that prevents the image quality deterioration on human visibility by suppressing occurrence of ununiformization of the resolution that is generated optically or electrically. Hereafter, the task that the present invention tries to solve will be described specifically.

Here, an optical lens is mounted on the image projection system for projecting an image onto the projection plane. However, as is known by the MTF (Modulation Transfer Function) curve, the lens has a characteristic that the image projected using a portion away from the center of the lens is inferior to the image using the center of the lens in resolution. Here, the resolution is an index indicating a capability of rendering details that the object (projected image etc.) being able to define a size of the physical image has. For example, in the projected image projected and displayed from a projector, the resolution is decided by a ratio as to how many lines drawn by a width of one pixel can be represented per unit area. That is, even if the projection plane onto which the image projection system projects an image is flat, the resolution of the projected image does not become uniform from the viewpoint of the lens characteristic only by projecting the image with a focus being set optically on somewhere. In this case, in a pattern, there is a possibility that a certain portion thereof is displayed clearly but other portion is displayed as an unclear blurred image, so that deterioration in image quality may occur. Moreover, in the case where the projection plane onto which the image is projected is vast, or where the projection plane has at least partially an uneven portion, a distance between a lens part of the image projection system, such as a projector, and the projection plane of the image varies largely and becomes different from place to place in the projection plane. In this case, a focus cannot be optically decided uniquely. Therefore, since at least one portion of the image is displayed certainly in a state of out-of-focus, the resolution of this one portion will be deteriorated. If it is done so, the resolution will not be uniformized within the image and the image quality will deteriorate after all. For example, in the case where the projection plane is huge like a screen of movie, a distance between the lens part of the image projection system and the central part of the screen is obviously different from a distance between the lens part of the image projection system and a circumferential end part of the screen. Also in the case where the image is projected onto a projection plane that is uneven at least partially, the distance between the lens part of the image projection system and the projection plane varies greatly from place to place in the projection plane. In such cases, since the distance between the projector and the screen does not become fixed, a proper focus cannot be decided uniquely no matter how much the focus of the image is adjusted optically. Therefore, in some portion of the projected image, the focusing is not made and the resolution will deteriorate. The above is ununiformity in the resolution of the projected image that is generated by an optical factor. However, this factor will leads to a situation where a clear image cannot be projected after all even if a technology of adjusting the size and the focus parameter (a diaphragm) optically is used by detecting the distance between the projector and the screen using the above-mentioned infrared sensor etc.

Although the above is the explanation of the ununiformization of the resolution due to the optical factor, the ununiformization of the resolution is generated also not only by the above-mentioned optical factor but also by the electrical factor. The above-mentioned technology disclosed by Japanese Patent Application Publication No. 2010-171774 is a technology of correcting distortion of the shape (hereinafter, referred to as geometric distortion) in the displayed image regardless of the uneven surface of the projection plane. However, the image that is geometric distortion corrected and displayed will lower in resolution compared with the image displayed before the correction and its image quality will be deteriorated, as will be described below.

The image on which geometric distortion correction is performed becomes ununiform in resolution. The geometric distortion correction is realized by changing the number of pixels to the image that is an object of projection. Usually, at the time of projection, the number of pixels being made to emit light by the projector is set to be the maximum. Then, the shape is corrected by decreasing the number of pixels of the projection object in which the geometric distortion is detected in the image after the projection compared with the original image. As a more concrete method, for example, the number pixels of the pertinent portion in the projection object is decreased by reducing the image size of a portion where the number of pixels is intended to be changed in the projection object. This reduction is performed so that distortion of the shape of the image that comes out when being actually projected may be removed. Then, if the image is reduced, the number of pixels used in order to represent a reduced portion will also decrease. That is, the correction of the geometric distortion means reducing the number of pixels that represent a certain portion in terms of results. Then, from this fact, a predetermined part of the projection object that is geometric distortion corrected will suffer deterioration in the resolution. This deterioration in the resolution will be explained below.

Here, the resolution is an index indicating the rendering capability of a fine part that the object (projection image etc.) has and whose physical image size can be defined, as described above. For example, it is decided by a ratio as to how many lines each of which is drawn by a width of one pixel can be rendered per unit area in the projected image that is projected from the projector and is displayed. As an example, let a case be considered where the image shown in FIG. 16 is projected onto the screen from the projector before the projection. One box in FIG. 16 represents one pixel. Therefore, the image of FIG. 16 is ten line segments of the identical length and having a width of one pixel are drawn on the screen in a vertical direction in parallel at one pixel intervals with their starting point and end points arranged at equivalent positions. In this case, it will be recognized that ten pixels are used for horizontal one line of these lines. Now, assuming that 20 pixels in the horizontal one line constitute a unit region, ten dots will be able to be drawn in the unit region using 10 pixels among the horizontal 20 pixels. If the number of dots is increased horizontally more than this, dots adjoin and it becomes impossible to distinguish them as individual dots. Now, since the reduction of the image is not performed, ten dots can be drawn using 20 pixels in the horizontal direction, either in horizontal one line corresponding to end points of ten lines, or in horizontal one line other than these, similarly. These dots do not overlap each other in the horizontal direction and adjoin one another in the vertical direction, forming separate ten line segments shown in FIG. 16. If this image is projected onto the screen and is made to form the image with a focus made on the screen, the image will be displayed in a form that enables ten lines to be recognized correctly; therefore, the resolution that this displayed image has will be 10.

Here, in order to perform the above-mentioned geometric distortion correction, let it be considered to reduce the image. For example, for example, consider a case where when the above-mentioned image of FIG. 16 is projected from the projector, the width becomes thicker as a point of interest approaches the end point of the line segment, and the line segment is seen being blurred. This occurs, for example, when the screen is slanted to a plane on which the projector is disposed, i.e., from a vertical plane. Specifically, supposed that a focus center that is a focus of the image is set at the starting point of the line segment or its vicinity, a deviation between the focus center and a real focus becomes larger as the point of interest approaches the end point of the line segment, and the image tends not to make a focus correctly at the focus. Because of this, the width of the line segment becomes thicker as approaching the end point of the line segment, and it will be seen being blurred. In order to cancel the blurring caused by this broadening of the displayed image, the geometric distortion correction will be performed on the image before the projection of FIG. 16. In that case, for example, a method of reducing the size of the image by a larger ratio as the point of interest approaches the end point of the line segment can be considered.

Since the image before the projection is reduced according to need, broadening of the display object that is occurring originated from the tilt of the screen, i.e., the above-mentioned growing fat of the line segment will be cancelled. However, there is a case where the image is not projected onto the screen in a correct and original form due to the above-mentioned deterioration in the resolution depending on the degree of reduction.

That is, considering the reduction of the image by the above-mentioned method, the image before the projection that is a square of 20 pixels by 20 pixels in FIG. 16 is transformed into a keystone shape whose lower base is shorter than its upper base before the projection, that is, correction of the geometrical distortion is performed. At this time, as the point of interest approaches the lower base of the keystone, the number of pixels that can be used in order to represent the line segment decreases. FIG. 17 is referred to in order to explain this. The pixels with slanted lines in FIG. 17 are pixels that became unusable by the reduction of the image. Since the pixel with the slanted lines will not be used for representation of the line segment, the pixel cannot be made to emit light even by a light source of the projector. It turns out that remaining pixels that are not given the slanted lines form an approximate keystone. Then, since in the upper base, the reduction is not performed, 10 pixels are usable in order to represent the line segment. On the other hand, in the lower base, the reduction was performed by the largest ratio, and consequently, only five pixels can be used in order to represent the line segment. When trying to draw ten line segments of one dot width in this state, ten lines departing from the starting point of the line segment will gather at the end point of the line segment in which only five pixels exist. This has an effect that, when the point of interest approaches the lower base of the keystone, the line segments become overlapped each other, and the vicinity of the end point of the line segment in the lower base become a state where regions being painted over with black exist much. If the image in this state is projected onto the screen by the projector, ten line segment are not displayed correctly as shown in FIG. 16, and an image such that the width of the line segment is swelled and is painted over with black will be displayed on the screen as the point of interest approaches the end point of the line segment in FIG. 16.

This means that the number of line segments that can be drawn per unit region in the lower base portion becomes small as compared with the upper base portion of the keystone, and as a result the resolution of the image being displayed has fallen. Now, let it be assumed that a range of 20 pixels in the horizontal one line is considered as a unit region. Under this assumption, since there is only five pixels in the lower base portion, the number of the line segments that can be drawn to the unit region of 20 pixels in the horizontal one line has fallen to five lines. Therefore, five or more line segments running from the upper base to the lower base are intended to be drawn, overlapping of the line segments certainly occurs in the vicinity of the lower base portion. When the image before the projection in such a state is displayed by the projector, the line segments that cannot be recognized as separate line segments but as a line segment with a fatted width are displayed on the projection plane. As a result, the number of line segments that can be represented per unit region of the projected image will decrease, or the image will be displayed on the projection plane in a state where the line segments cannot be recognized at all because of being painted over with black. That is, this means that the resolution has fallen.

The correction of the geometric distortion may cause the fall of the resolution in this way. Premised on the above, Japanese Patent Application Publication No. 2010-171774 will be further analyzed.

Here, using FIG. 18 to FIG. 22, a keystone correction that is one example of the correction of the geometrical distortion and was described also in the above-mentioned concrete example will be explained. FIG. 18 and FIG. 19 are diagrams for explaining the relationship between the image projection system and the screen pertaining to a related art. An image projection apparatus 500 described in FIG. 18 and FIG. 19 shall be able to perform projection P1 of an original image GO inputted from the outside onto a screen S1 and shall be able to perform photographing P2 of the image displayed on the screen S1. Then, the image projection apparatus 500 shall perform the keystone correction on a photographed image and shall re-project it. Incidentally, the original image GO shall be an image having a rectangular shape.

Here, FIG. 18 represents the screen S1 with an x-axis that is a width direction and a y-axis that is a height direction. The figure shows that the screen S1 is a rectangle of a width Xs and a height Ys. Moreover, FIG. 19 represents the screen S1 with the y-axis and the z-axis that is a depth direction. That is, the figure shows that a projection distance from the image projection apparatus 500 differs in a y-axis direction on the screen S1. Here, a maximum of the difference in projection distance shall be a depth Zs.

Next, FIG. 20 is a diagram showing an example of a photographed image G1 when the image projection apparatus 500 performs the projection P1 of the original image G0 onto the screen S1 and performs the photographing P2. FIG. 20 shows that a shape of the photographed image G1 is distorted due to an influence of the depth Zs. That is, the photographed image G1 is a trapezoid with an upper base width Xs1 and a lower base width of Xs2. Since the point of interest moves in a positive direction of the y-axis, the depth of the screen increases and the projected photographed image G1 is widened, Xs2 is larger than Xs1 in width.

Here, FIG. 21 is a diagram showing an example of a keystone corrected image G2 when the image projection apparatus 500 performs the keystone correction on the original image GO based on the photographed image G1. Incidentally, the keystone corrected image G2 shows an image in a state where the image projection apparatus 500 holds it in its internal memory etc. after the correction and before the re-projection. FIG. 21 shows that the keystone corrected image G2 is a reverse trapezoidal shape of the photographed image G1. That is, the keystone corrected image G2 is a trapezoid with an upper base width Xs2 and a lower base width Xs1.

FIG. 22 is a diagram showing an example of a photographed image G3 after the keystone correction when the image projection apparatus 500 performs projection P1 of the keystone corrected image G2 again onto the screen S1 and performs photographing P2 again. FIG. 22 shows that the photographed image G3 after the keystone correction is a projected image when the original image G0 is displayed, for example, on unevenness-free flat plane, that is, a rectangle shape that is shortened in an x-axis direction by a width Xs3 at both ends compared with an image with a shape that is originally intended to be displayed. That is, the photographed image G3 after the keystone correction is a rectangle with both an upper base width and a lower base width equal to Xs1. Incidentally, the photographed image G3 after the keystone correction can be rendered as an image almost of the same size as the display size of the original image G0 that is intended to be displayed by optically enlarging it in the x-axis direction or by other ways when the image projection apparatus 500 performs projection P1 again. Incidentally, as the above-mentioned explanation, if the lower base has a longer projection distance than the upper base does and the projection size becomes larger, its correction object will not remain in the x-axis direction, but actually, a need of correction in the y-axis direction arises. It is because the size of the image projected also in the y-axis direction becomes larger as the point of interest approaches the lower base. If the correction is not performed also in the y-axis direction, it will occur that circularity and an aspect ratio (ratio of width and height of the screen; 16:9, 4:3, etc.) are not compensated and the correction is recognized as an erroneous geometric distortion correction.

That is, the image projection apparatus 500 performs projection P1 of a trapezoid of a reverse shape to the displayed trapezoid in the photographed image G1 as the keystone corrected image G2. Thereby, when the image is displayed on the screen S1, the image is distorted into a trapezoid and, as a result, a difference between the upper base and the lower base is cancelled, so that the image is displayed having generally uniform lengths, namely in a shape approaching a rectangle. The above is an explanation of the keystone correction.

Following this, a problem that occurs when the shape correction, the technology of Japanese Patent Application Publication No. 2010-171774, is applied to the screen having an uneven surface will be explained using FIG. 23 to FIG. 26. FIG. 23 is a diagram for explaining a relationship between an (portable) image projection apparatus 501 according to Japanese Patent Application Publication No. 2010-171774 and a screen S2 having the uneven surface. The image projection apparatus 501 performs projection P1 of the original image GO inputted from the outside onto the screen S2, performs photographing P2 of the image displayed on the screen S2, divides the photographed image into a plurality of regions, performs the geometric distortion correction for every region, and re-projects it.

Here, although the screen S2 is the same as the screen S1 in regard to the x-axis direction and the y-axis direction, it shall have an uneven surface on the projection plane. In FIG. 23, on the screen S2, the maximum of the difference in projection distance from the image projection apparatus 501 shall be the depth Zs. Specifically, the screen S2 has projection points Sp21 to Sp25 whose projection distances are different, respectively.

FIG. 24 is a diagram showing an example of the screen S2 having the uneven surface and the divided regions. FIG. 24 shows that, on the screen S2, a difference in depth between the projection point Sp23 whose projection distance from the image projection apparatus 501 is shortest and the projection point Sp21 is a depth Zs1. Similarly, the figure shows that a difference in depth between the projection point Sp23 and the projection point Sp25 is a depth Zs2, a difference in depth between the projection point Sp23 and the projection point Sp22 is a depth Zs3, and a difference in depth between the projection point Sp23 and the projection point Sp24 is a depth Zs4.

Moreover, FIG. 24 shows that the image is divided into five regions in the x-axis direction when the image projection apparatus 501 performs photographing P2. Specifically, the figure shows that they are a region R1 centering on the projection point Sp21, a region R2 centering on the projection point Sp22, a region R3 centering on the projection point Sp23, a region R4 centering on the projection point Sp24, and a region R5 centering on the projection point Sp25. Further, the figure shows that the regions R1 to R5 have widths Xso1 to Xso5, respectively. Incidentally, here, the sizes of the widths Xso1 to Xso5 are regular intervals for convenience of explanation.

FIG. 25 is a diagram for explaining a relationship between an original image G20 at the time of applying Japanese Patent Application Publication No. 2010-171774 to the above-mentioned example and a photographed image G21. The photographed image G21 is an acquired image when the image projection apparatus 501 performs projection P1 of the original image G0 onto the screen S2 and performs photographing P2. FIG. 25 shows that the widths of the regions R1 to R5 in the photographed image G21 are set to widths Xsp1 to Xsp5, respectively. Here, the figure shows that since the screen S2 has the uneven surface in the x-axis direction, the widths Xsp1, Xsp2, Xsp4, and Xsp5 have become different widths from the widths Xso1, Xso2, Xso4, and Xso5, respectively. That is, the figure shows that the geometric distortion is occurring in the photographed image G21.

FIG. 26 is a diagram for explaining a relationship between a corrected image G22 of the original image and a photographed image G23 of a corrected image according to Japanese Patent Application Publication No. 2010-171774. Based on the photographed image G21, the image projection apparatus 501 performs correction P3 of the geometric distortion on the original image G20 on a region-to-region basis, and generates the corrected image G22 of the original image. FIG. 26 shows that in the corrected image G22 of the original image, scaling was changed to widths Xsc1 to Xsc5 in the regions R1 to R5, respectively.

Here, the image projection apparatus 501 shall perform scaling, i.e., a correction of the geometric distortion on the regions R1 to R5 based on reciprocals of ratios of the respective widths Xso1 to Xso5 and the respective widths Xsp1 to Xsp5. The correction of the geometric distortion here will decrease the number of pixels in the x-axis direction compared with the original image G20. That is, the resolutions of the respective regions of the corrected image G22 of the original image decrease compared with those of the original image G20. For example, let it be assumed that the resolutions of the regions R1 to R5 become “90%,” “70%,” “100%,” “60%,” and “80%,” respectively.

Then, the image projection apparatus 501 performs projection P4 of the corrected image G22 of the original image onto the screen S2, performs photographing P5, and acquires the photographed image G23 of the corrected image. As a result, the photographed image G23 of the corrected image is displayed with the regions R1 to R5 corrected to have the widths Xso1 to Xso5, respectively. That is, the figure shows that compared with the photographed image G21, the photographed image G23 of the corrected image is recognized as an image with the geometric distortion corrected and closer to the original image G20.

From the above, the correction of the geometric distortion in Japanese Patent Application Publication No. 2010-171774 only corrects locally the distortion that occurred locally. More specifically, it only alters the scaling of display of a location of distortion occurrence. Then, the scaling is performed by different scaling factors (reduction ratio) according to the shape of each region. As a result, any region can have a different scaling factor for each of the adjacent regions. For this reason, even if the geometric distortion itself is corrected, the resolutions of the respective regions will differ. Describing further about it, the above-mentioned resolution falls in every region where a localized size reduction is performed, and further a degree of the fall differs for each region. Therefore, for example, when a still image is projected, the variation in resolution occurs in the projected still image for every region, and visual performance for human being becomes unnatural. Moreover, for example, when a moving image in which an object having a fine pattern moves is projected, the fine pattern that comes out clearly in a certain portion on the screen will come out being blurred in another portion on the screen, which results in an obviously unnatural display of the moving image. That is, the image quality of the projected image (including the still image and the moving image) will deteriorate.

Moreover, similar problems occur in the above-mentioned technologies disclosed by Japanese Patent Application Publication No. 2005-326247 and Japanese Patent Application Publication No. 2006-033357.

In addition, the technology disclosed by Japanese Patent Application Publication No. 2007-306613 is one that recognizes a projection area by acquiring a screen projected image with an image sensor and adjusts the projection area to the screen. However, since Japanese Patent Application Publication No. 2007-306613 premises that the projection plane is a planar surface, in the case where the projection plane is uneven or a curved surface, there will exist a region where a size, a display position, or a focus is unsatisfactory. That is, the ununiformization of the resolution caused by the optical factor will occur.

In addition, the technology disclosed by Japanese Patent Application Publication No. 2001-083949 is one that uses the image sensor and puts its object only on the geometric distortion correction. Therefore, the correction becomes possible for the geometric distortion correction and the size and display position that accompany it. However, with Japanese Patent Application Publication No. 2001-083949, the focus characteristic of the whole screen will remain ununiform and is unsatisfactory as an image quality grade.

Incidentally, even if technologies disclosed by Japanese Patent Application Publication No. 2006-201548, Japanese Patent Application Publication No. 2006-109380, Japanese Patent Application Publication No. 2004-229290, and Japanese Patent Application Publication No. 2010-212917 described above are used, the above-mentioned problems cannot be solved.

The image projection system according to a first aspect of the present invention outputs an image from the lens and projects it onto a projection plane, and also corrects resolutions of the respective region of the image and projects the image onto the projection plane based on an inverse characteristic of an optical characteristic of the lens when the resolution of each region of the image projected onto the projection plane is not uniform among respective regions. Thereby, the ununiformity of the projected image resolution that is generated by the optical factor is canceled.

The image projection system according to a second aspect of the present invention projects an image that is made deteriorated so that the resolutions of other regions may be substantially the same as the resolution of one region, when the resolution of the one region of the projected image falls below the resolutions of the other regions by projecting the image onto the projection plane so that a shape of the image may not be distorted. Thereby, the ununiformity in the resolution generated by the electrical factor is canceled.

The semiconductor integrated circuit according to a third aspect of the present invention output an image that is deteriorated so that the resolutions of other regions may become substantially the same as the resolution of the resolution of one region, when the resolution of the one region of the projected image becomes lower than the resolutions of other regions by projecting the image so that a shape of the image on the projection plane may not be distorted.

An image projection system according to a fourth aspect of the present invention has: a projection part for projecting a target image onto the projection plane; a photographing part for photographing the projection plane onto which the target image is projected; an analysis part for analyzing the photographed image that is an image obtained by photographing the projection plane; and a correction part for correcting the target image based on an analyzed result; wherein the analysis part divides the photographed image into a plurality of regions and calculates the resolution for every region when a difference in shape between the target image and the photographed image is within a predetermined range, the correction part generates a first corrected image from the target image so that the resolutions among the regions may be uniformized, and the projection part projects the first corrected image onto the projection plane.

The semiconductor integrated circuit according to a fifth aspect of the present invention has: the analysis part for analyzing the photographed image that is an image obtained by photographing the projection plane onto which the target image is projected; and a correction part for correcting the target image based on an analyzed result; wherein the analysis part divides the photographed image into a plurality of regions and calculates the resolution for every region when the difference in the shape between the target image and the photographed image is within the predetermined range, and the correction part generates the first corrected image from the target image so that the resolutions among the regions may be uniformized.

If resolutions of one region and other regions of a certain image differ, the human eyes react sensitively to the difference in how the image comes out and recognize the image as a blurred and indistinct image. However, on the other hand, even if the resolution of the image has fallen in the one region, the human eyes cannot recognize the deterioration in the resolution if the resolution has also fallen in the other region in substantially the same manner, and the human being will have an illusion that the image is displayed at an excellent image quality. The solution means described above uses this very characteristic of human eyes skillfully.

According to the present invention, it is possible to prevent the image quality deterioration on human visibility by suppressing occurrence of the ununiformization of the resolution that is generated optically or electrically.

### BRIEF DESCRIPTION OF THE DRAWINGS

FIG. 1 is a block diagram showing a configuration of an image projection system according to a first embodiment of the present invention.

FIG. 2 is a block diagram showing a configuration of an LSI according to the first embodiment of the present invention.

FIG. 3 is a flowchart showing a flow of an image adjustment processing according to the first embodiment of the present invention.

FIG. 4 is a flowchart showing a flow of a target image setting processing according to the first embodiment of the present invention.

FIG. 5 is a flowchart showing a flow of an optical correction processing according to the first embodiment of the present invention.

FIG. 6 is a flowchart showing a flow of a geometric distortion correction processing according to the first embodiment of the present invention.

FIG. 7 is a flowchart showing a flow of a resolution correction processing according to the first embodiment of the present invention.

FIG. 8 is a flowchart showing a flow of a luminance correction processing according to the first embodiment of the present invention.

FIG. 9 is a diagram showing an example of a target image according to the first embodiment of the present invention.

FIG. 10 is a diagram showing an example of a photographed image obtained by photographing the target image that is projected onto a projection plane according to the first embodiment of the present invention.

FIG. 11 is a diagram showing an example of a corrected image obtained by geometric distortion correcting the target image according to the first embodiment of the present invention.

FIG. 12 is a diagram showing an example of the image obtained by inserting a test pattern into the corrected image according to the first embodiment of the present invention.

FIG. 13 is a diagram showing an example of variation in resolution of the whole image according to the first embodiment of the present invention.

FIG. 14 is a diagram showing an example of the variation in the resolution within a region according to the first embodiment of the present invention.

FIG. 15 is a diagram showing an example of the corrected image whose resolution within the region is corrected according to the first embodiment of the present invention.

FIG. 16 is a diagram showing an example of the image that becomes an object to be projected onto a screen from the projector pertaining to a related technology.

FIG. 17 is a diagram showing an example of a keystone correction of the image pertaining to the related technology.

FIG. 18 is a diagram for explaining a relationship between the image projection system and the screen pertaining to a related technology.

FIG. 19 is a diagram for explaining the relationship between the image projection system and the screen pertaining to a related technology.

FIG. 20 is a diagram showing an example of the image whose original image is projected pertaining to a related technology.

FIG. 21 is a diagram showing an example of the corrected image whose original image is keystone corrected pertaining to a related technology.

FIG. 22 is a diagram showing an example of the image whose corrected image is projected pertaining to a related technology.

FIG. 23 is a diagram for explaining a relationship between the image projection system and the screen having an uneven surface pertaining to a related technology.

FIG. 24 is a diagram showing an example of the screen having the uneven surface and divided regions pertaining to a related technology.

FIG. 25 is a diagram for explaining a relationship between the original image and a projected image pertaining to a related technology.

FIG. 26 is a diagram for explaining a relationship between the corrected image and the projected image pertaining to a related technology.

### DETAILED DESCRIPTION

Hereafter, concrete embodiment to which the present invention is applied will be described in detail referring to drawings. In each drawing, the same symbol is given to the same component and for clarification of the explanation, and repeated explanations are omitted as needed.

### First Embodiment

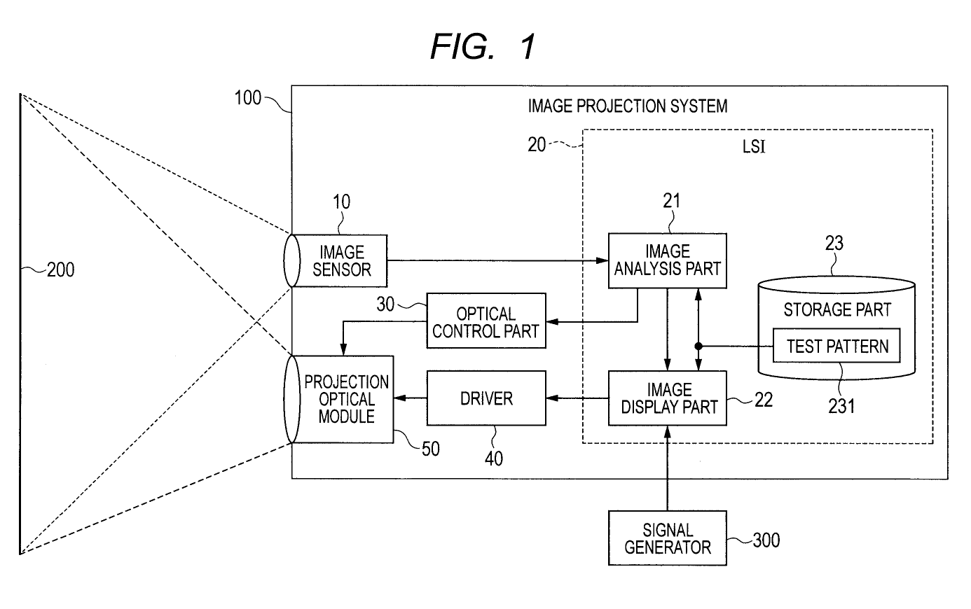

FIG. 1 is a block diagram showing a configuration of an image projection system 100 according to a first embodiment of the present invention. By the image projection system 100 projecting a target image generated based on a test pattern that is registered in advance and will be described later, and adjusting the target image appropriately based on a photographed image photographed from a projection plane 200, image quality of the image displayed on the projection plane 200 is maintained at fixed quality. Thereby, an appropriate image can be displayed according to a form of the projection plane 200. Alternatively, it is all right to configure the image projection system 100 to project an input signal of a video or image received from a signal generator 300 onto the projection plane 200 and adjust the input signal appropriately based on the image photographed from the projection plane 200. As one of concrete examples of this image projection system, a projector having a function of projecting the image onto the projection plane, such as a screen can be considered. Moreover, in recent years, a portable projector whose device scale is reduced is also appearing, and such a lightweight and small-scale projector can also be considered. In addition, it can be said that this image projection system complies with a system that realizes a function of illuminating and projecting an image from electronic devices, such as a personal computer.

The signal generator 300 is an apparatus for reading data, such as a video content, an image file, etc. and outputting it to the image projection system 100 as a signal. The signal generator 300 is a general-purpose computer, such as a personal computer, or a DVD (Digital Versatile Disc) playback system, for example.

That projection plane 200 is a predetermined region whose surface shape is not guaranteed to be generally flat. That is, it is a projection plane that includes an uneven form at least partially. Enumerating a concrete example, the projection plane 200 is one that has an uneven surface or curved surface shape. The uneven surface is, for example, an indoor wall surface or ceiling, i.e., one that has a notable difference in depth on the surface, such as wallpaper. Moreover, the projection plane 200 may be an outer wall of a building, a cylindrical pillar, etc. Incidentally, it is natural that even when the projection plane 200 is a screen for exclusive use whose surface is guaranteed to be a generally flat form, the first embodiment of the present invention is applicable to it. However, when the projection is done onto the projection plane 200 described above, the effect of the first embodiment of the present invention is exerted more.

Here, the image projection system 100 is equipped with an image sensor 10, an LSI (Large Scale Integration) 20, an optical control part 30, a driver 40, and a projection optical system module 50. Here, the projection optical system module 50 includes a panel lens group, such as DMD/LCD, a light source, etc., for example.

The image sensor 10 is a photographing part for photographing the projection plane 200. Therefore, when the image is projected onto the projection plane 200, the image sensor 10 can photograph contents displayed on the projection plane 200 as an image. The image sensor 10 is a CCD (Charge Coupled Devices) sensor etc., for example.

The LSI 20 is a semiconductor integrated circuit for processing the input signal of a video or image. The LSI 20 makes the projection optical system module 50 project the input signal received from the signal generator 300 through the driver 40. Moreover, the LSI 20 performs analysis and correction of the photographed image photographed by the image sensor 10 and makes the projection optical system module 50 re-project it. Incidentally, the LSI 20 can also correct the photographed image using not only the input signal received from the signal generator 300 but also the test pattern registered in its interior in advance.

The LSI 20 is equipped with an image analysis part 21, an image display part 22, and a storage part 23. The storage part 23 is a storage apparatus that has stored in advance a test pattern 231 that is various image data for adjusting the target image. The test pattern 231 may be a crosshatch, a resolution chart, W raster, etc., for example. The crosshatch is a test pattern used in order to correct a size, a position, or geometric distortion. The crosshatch may be a plurality of straight lines arranged at equal intervals vertically and horizontally in a form of a grating. The resolution chart may be, for example, a plurality of straight lines of a predetermined thickness. That is, the test pattern 231 may be a plurality of partial images of an identical shape.

The image analysis part 21 is an analysis part for analyzing the photographed image that is an image of the projection plane 200 photographed by the image sensor 10. The image display part 22 is a correction part for correcting the target image based on a result analyzed by the image analysis part 21. Here, the image analysis part 21 calculates the difference of the shape between the photographed image and the target image. This is a processing to be conducted in the following purposes: for deciding a focus center that is a portion where the photographed image is focused; for correcting deterioration in the resolution of the photographed image arising from the difference in projection distance from the focus center; and further for correcting the geometric distortion described above. A processing that the image analysis part 21 decides the focus center will be described later. Moreover, the image analysis part 21 performs a processing for correcting the resolution of each region of the photographed image based on an inverse characteristic of an optical characteristic that the lens has on the photographed image. Then, when the difference in the shape between the photographed image and the target image is within a predetermined range, namely when it is not necessary to perform geometric distortion correction from the beginning, or when it is not necessary to perform the geometric distortion correction any more, the image analysis part 21 divides the photographed image into a plurality of regions and calculates the resolution for every region. When the resolution of one region of this photographed image has fallen below the resolution of another one region, the image display part 22 deteriorates the resolution of the another one region so that it may become substantially the same as the resolution of the one region. Repeating this, the resolutions of the respective regions are adjusted so that the resolution becomes substantially the same in each of the regions that the photographed image has. Since there are some examples about concrete techniques of deteriorating the resolution, this point will be described later. Note that, in this specification, the image whose regions have substantially the same resolutions as a result of performing the processing of deteriorating the resolutions shall be referred to as a first corrected image. In connection with this, the projection optical system module 50 projects the first corrected image onto the projection plane 200. Thereby, it is possible to uniformize the resolutions about the image projected onto the projection plane. Although the resolutions are deteriorated, the resolutions are deteriorated to be substantially the same level in the respective regions of the image, and human eyes are given an illusion that the image is projected with good image quality, without noticing the deterioration of the resolutions. That is, it is possible to prevent deterioration in the image quality on human vision.

Furthermore, the image analysis part 21 calculates the luminance for each of the regions concerned when a difference in resolution between the regions in the photographed image is within the predetermined range. This is a processing to be performed when an adjustment of resolution does not need to be conducted from the beginning or when after the adjustment, the adjustment of resolution does not need to be conducted further. Then, the image display part 22 generates a second corrected image from the first corrected image so that the luminances among the regions may become uniform. That is, when the luminance value of one region of the photographed image has fallen below the luminance value of other one region, the luminance of the other one region is reduced so as to be substantially the same as the luminance value of the one region. Since when the luminance value of the one region is different from the luminance value of the other region, the brightness of the screen varies partially to human eyes, he/she has sense of incongruity as to how the image comes out. However, when the luminance value of the other region has fallen substantially equivalently with the luminance value of the one region, the human produces an illusion and do not have sense of incongruity. Therefore, by performing the above-mentioned adjustment of luminance over the whole screen, the luminance value over the whole screen falls substantially uniformly and it does not occur that the image comes out unnatural to human eyes. In connection with this, the projection optical system module 50 projects the second corrected image onto the projection plane 200. Thereby, the luminance of the image projected onto the projection plane can be adjusted, and deterioration in the image quality on human vision can be suppressed further.

Moreover, the image display part 22 generates a third corrected image by correcting the geometric distortion of the target image based on a difference in shape when the difference in the shape is outside the predetermined range, In connection with this, the projection optical system module 50 projects the third corrected image onto the projection plane 200. Then, when the difference in the shape between the photographed image and the target image is within the predetermined range, the image analysis part 21 calculates the resolution for every region in the photographed image. Then, the image display part 22 generates the above-mentioned first corrected image based on the third corrected image. Thereby, it is possible to improve the image quality even when the resolution becomes ununiform in connection with the geometric distortion correction.

In particular, the image display part 22 generates the first corrected image so that the resolutions of respective regions may become uniform according to the uneven surface. Thereby, it is possible to adjust the quality of image to be a predetermined level on human vision even when the projection plane has various forms.

The optical control part 30 performs optical controls, such as an adjustment of the lens, in the projection optical system module 50. Since the projection optical system module 50 includes a plurality of lenses, it is possible to adjust a position of the focus center by altering a relative positional relationship of these lenses. That is, the optical control part 30 is a control part for controlling the relative positional relationship of the lens that the projection optical system module 50 contains. The driver 40 controls the projection optical system module 50 electrically, and drives it. The projection optical system module 50 projects the image onto the projection plane 200 based on the input signal received through the driver 40.

The image projection system 100 acquires the photographed image by photographing the image projected onto the projection plane by the projection optical system module 50 with the image sensor 10. Then, the image projection system 100 detects the difference between the photographed image and the ideal target image being set up in advance and corrects the target image based on the difference. At this time, the image projection system 100 performs a feedback processing of repeating the projection and photographing of the target image after the correction and optical and electrical corrections until the differences in shape, resolution, and luminance fall within arbitrary tolerances being set up by a user.

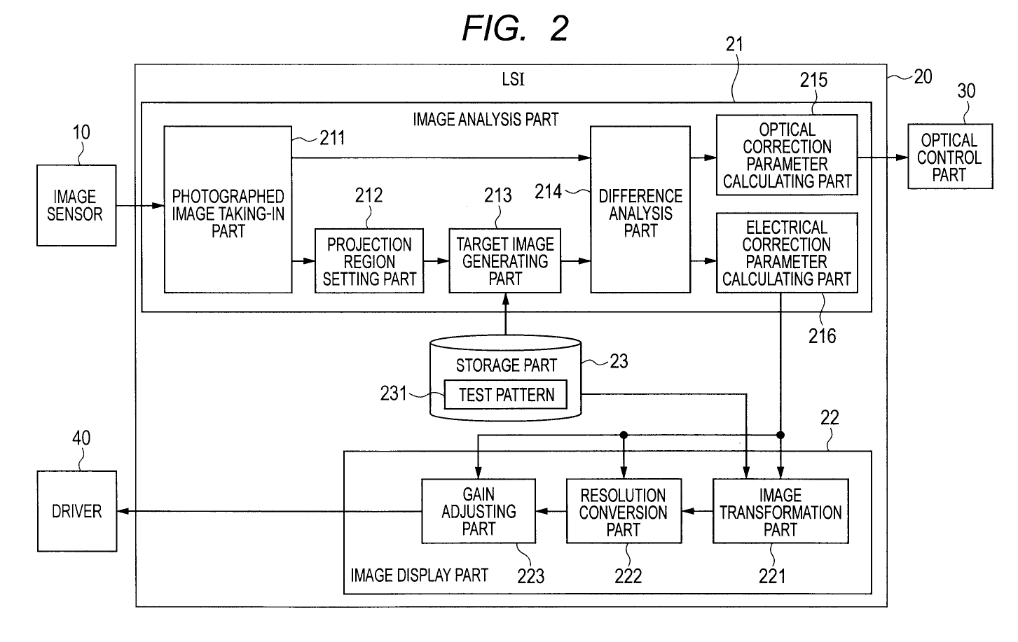

FIG. 2 is a block diagram showing a configuration of the LSI 20 according to the first embodiment of the present invention. The image analysis part 21 is equipped with a photographed image taking-in part 211, a projection area setting part 212, a target image generating part 213, a difference analysis part 214, an optical correction parameter calculating part 215, and an electrical correction parameter calculating part 216. The photographed image taking-in part 211 takes in the photographed image photographed from the projection plane 200 with the image sensor 10. For example, the photographed image taking-in part 211 acquires data of RGB as the photographed image. The projection area setting part 212 sets up a projection area that is a region for projecting the target image for the photographed image in the projection plane 200 before the target image is projected.

Specifically, the projection area setting part 212 receives specification of coordinates that define the region of the projection area from the user, sets up the coordinates on the photographed image, and designates the region within the coordinates being set up as the projection area. Incidentally, the coordinates of the projection area may be stored in the storage part 23 in advance. In that case, the projection area setting part 212 reads the coordinates of the projection area from the storage part 23, and sets up the projection area.

Moreover, the coordinates of the projection area may just be coordinates of four corners for defining a rectangle, or standard coordinates of center coordinates etc. of the projection area and what define the size or its shape of the projection area, for example. Therefore, the projection area does not need to be a rectangle and may be a polygon, a curvilinear area, a circle, or the like. Incidentally, by performing setting of the projected image on the projection plane 200 before the projection of the target image each time, the projection area setting part 212 can set up an optimal region considering a peripheral environment including the projection plane 200 and a capability of the projection optical system module 50.

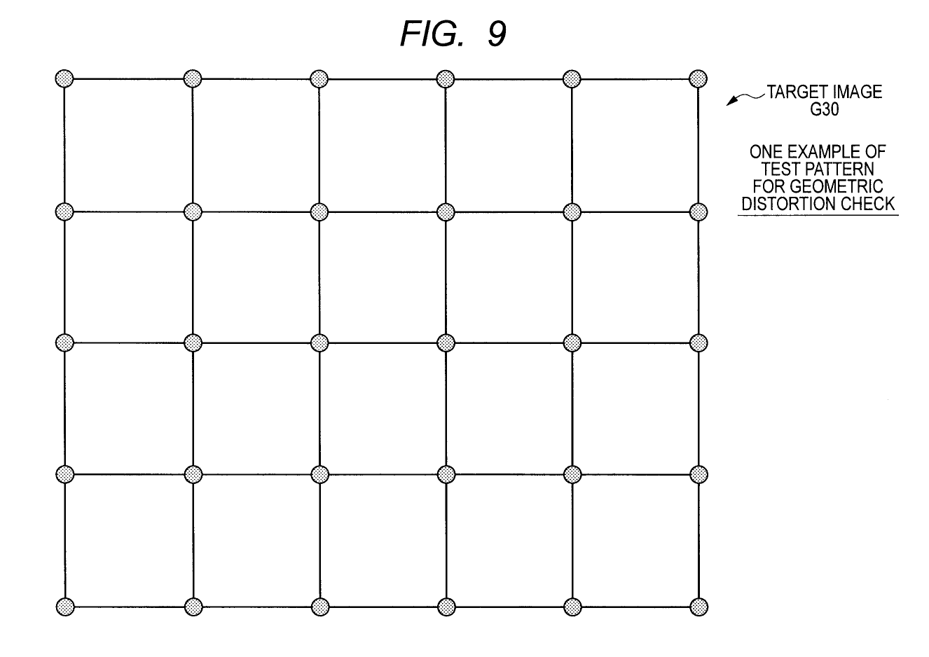

The target image generating part 213 generates an object image that is the target image projected onto the projection plane 200. Specifically, the target image generating part 213 reads the test pattern 231 from the storage part 23, processes the test pattern 231 so that it may fit in the projection area being set up by the projection area setting part 212, and thereby generates the target image. Incidentally, the target image generating part 213 may designate an image based on the input signal received from the signal generator as the target image without using the test pattern 231. Incidentally, FIG. 9 shows an example of the target image. Here, the target image is divided into the regions for the respective lattices by a crosshatch pattern in a grating form, as an example. The size of this lattice needs to be such that the area of the region enables the geometric distortion correction to be performed. The smaller the size of the lattice, the finer the geometric distortion correction can be performed, but an operation amount will increase accordingly. In the case where the projection plane is a curve line along the x-axis as in FIG. 24, if the lattice has a lattice size that does not contain two or more inflection points within the lattice, the geometric distortion correction can be performed properly at worst. Moreover, the target image generating part 213 sets up the tolerance for when adjusting the image in the image projection system 100. The tolerance is what defines a display position, a display size, and an adjustment width of the focus center regarding the optical correction and what defines a shape, a resolution, an adjustment width to the luminance, color, or the like. For example, the adjustment width is represented by a ratio of an upper limit and a lower limit, etc.

The difference analysis part 214 calculates a difference between the target image and an actually projected image, e.g. the photographed image of the test pattern, and calculates a distance between the projection plane 200 and the projection optical system module 50 (hereinafter, referred to as a projection distance) and reflectance of the projection plane 200. For example, the difference analysis part 214 finds a relative projection distance of each region of the image that is projected based on how much degree the photographed image of each region is displayed being blurred compared with the target image of each region corresponding thereto. Then, the difference analysis part 214 determines which region should be used as the focus center from this relative projection distances. More specifically, the difference analysis part 214 checks a degree of blurring of each region of the photographed image and recognizes a region of the least blurring as the current focus center. Here, a region that is intended to be the focus center originally is a region whose distance from a lens part of the image projection system is intermediate among the projection distances. This is because deterioration of focusing performance according to a distance from the focus center is suppressed and controlled to a minimum by setting up the focus center in a region whose projection distance is intermediate. Therefore, the difference analysis part 214 detects a region whose projection distance is intermediate among the projection distances of respective regions, and decides that region as the focus center. Moreover, the difference analysis part 214 finds luminance of each region from the reflectance of each region of the photographed image. Moreover, in the case where the target image that is intended to be displayed is divided into a plurality of regions by a pattern like the test pattern of FIG. 9 that will be described later, the difference analysis part 214 divides the photographed image according to the regions. Then, the difference analysis part 214 calculates differences in shape etc. between the target image and the photographed image for every divided region. Furthermore, the difference analysis part 214 calculates the resolution and the luminance of each region of the photographed image, and calculates differences of the resolution and the luminance between the regions within the photographed image.

The optical correction parameter calculating part 215 calculates an optical correction amount with which the optical control part 30 controls the lens etc. of the projection optical system module 50. As described above, the difference analysis part 214 decides which region should be used as the focus center for all the regions that the image projected onto the projection plane 200 has. Based on the position of the focus center decided by the difference analysis part 214, the optical correction parameter calculating part 215 calculates control information for adjusting relative positional relationships of respective lenses of the projection optical system module 50 so that a region specified by the difference analysis part 214 may become the focus center. This control information is the above-mentioned correction amount. Then, the optical correction parameter calculating part 215 outputs the calculated correction amount to the optical control part 30. The electrical correction parameter calculating part 216 calculates an electrical correction amount with which the driver 40 controls the projection optical system module 50. Then, the electrical correction parameter calculating part 216 outputs the calculated correction amount to the image display part 22. Here, the electrical correction amount includes, for example, a correction amount of the pixel value based on the inverse characteristic of the optical characteristic that the lens has, or a correction amount about the shape, the resolution, and the luminance that are described above, or the like.

The image display part 22 processes the target image, namely, corrects it according to the electrical correction parameter from the image analysis part 21, and outputs it to the driver 40. The image display part 22 is equipped with an image transformation part 221, a resolution conversion part 222, and a gain adjusting part 223. The image transformation part 221 corrects the size, the display position, and the geometric distortion of the target image based on the correction amount that the electrical correction parameter calculating part 216 calculated. Moreover, the image transformation part 221 reads the test pattern 231 from the storage part 23, and uses it for the correction appropriately. In order that the resolution conversion part 222 may uniformize the resolutions of the whole projection area, the resolution conversion part 222 performs a two-dimensional filter processing, super resolution, a sharpness processing, etc. on the image before the projection in order to electrically correct the pixel values of the image to be projected based on the inverse characteristic of the optical characteristic of the lens used in the projection optical system module 50. This is a processing for uniformizing the resolutions in the case where the resolutions of one image to be projected are not uniformized within the image because of factors of blurring due to variation in the distance between the projection plane and the lens part and the optical characteristic of the lens at a stage where the optical control part 30 decided the focus center. Furthermore, in the case where the resolutions of one image to be projected are not uniformized within the image as a result of the geometric distortion correction performed by the above-mentioned image transformation part 221, the resolution conversion part 222 also performs processing of uniformizing the resolution. Specifically, the resolution conversion part 222 performs adjustment between the resolution of the one region of the photographed image that is inputted to the LSI 20 through the image sensor 10 and the resolutions of other regions. In doing this, when the resolution of the one region is deteriorated, the resolution conversion part 222 deteriorates the resolutions of the other regions so that they may become substantially the same as the resolution of the one region. For example, an image whose resolution becomes lowest in the photographed and inputted image can be assigned to this one region. In that case, by the resolution conversion part 222 performing the above-mentioned processing, the resolutions in the photographed image can be uniformized by the most lowered resolution. By re-projecting the image whose resolutions are uniformized in this way onto the projection plane 200 from the projection optical system module 50, the image comes out as an excellent image whose deterioration of the resolution is unrecognizable to human eyes.

The gain adjusting part 223 performs an adjustment for uniformizing the luminance of the whole projection area for each color of RGB. Specifically, this gain adjusting part 223 performs the adjustment between the luminance of the one region of the photographed image inputted into the LSI 20 through the image sensor 10 and the luminances of other regions. In doing this, when the luminance of the one region has fallen, the gain adjusting part 223 deteriorates the luminances of the other regions so that they may become substantially the same as the luminance of the one region. For example, a region that comes out in the lowest luminance on the projection plane 200 due to an installation environment and the form of the projection plane 200 in the photographed and inputted image can be assigned to this one region. In that case, the luminance of the photographed image can be uniformized to the lowest luminance by performing the above-mentioned processing. By re-projecting the image whose luminance is uniformized onto the projection plane 200 from the projection optical system module 50, the image comes out as an image with an excellent luminance to human eyes.

Moreover, it is all right that the image transformation part 221 may update the target image appropriately in an image adjustment processing according to the first embodiment of the present invention. For example, different test patterns 231 may be used for the target image for correcting the geometric distortion and for the target image for correcting the resolution and the luminance. In that case, the image transformation part 221 may update the target image with the test pattern for resolution or luminance check, and may perform the geometric distortion correction on the target image after updating. Incidentally, updating of the target image may be realized by the target image generating part 213.

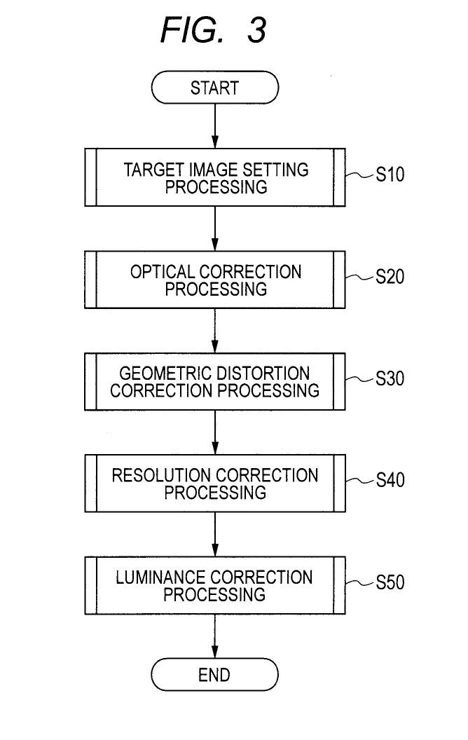

FIG. 3 is a flowchart showing a flow of the image adjustment processing according to the first embodiment of the present invention. First, the image projection system 100 performs a target image setting processing (S10). Next, the image projection system 100 performs an optical correction processing (S20). Then, the image projection system 100 performs a geometric distortion correction processing (S30). Following this, the image projection system 100 performs a resolution correction processing (S40). Subsequently, the image projection system 100 performs a luminance correction processing (S50). Below, each processing of Steps S10 to S50 will be explained in detail. Note that each image shown in the following FIG. 9 to FIG. 15 is illustrated schematically to explain the first embodiment of the present invention, and is not an exact image.

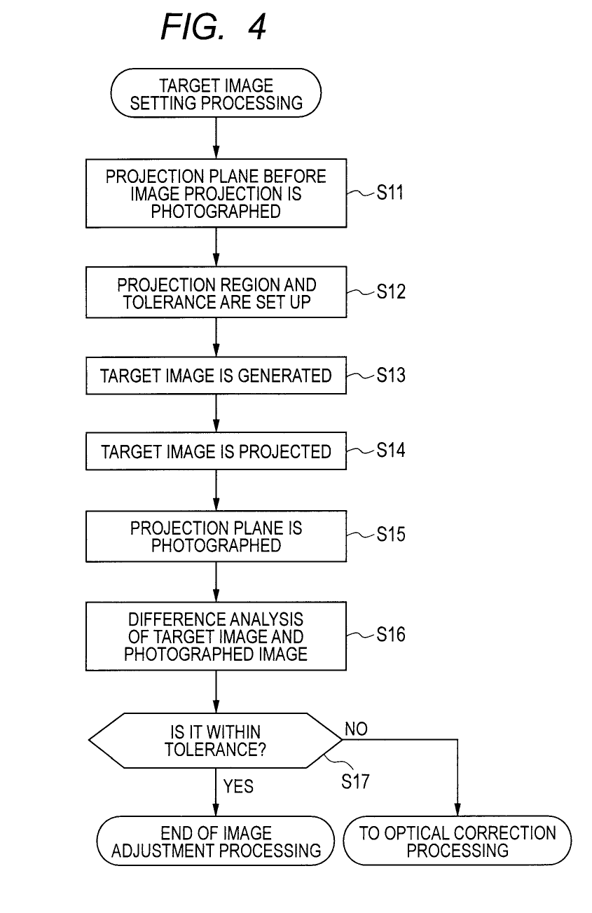

FIG. 4 is a flowchart showing a flow of the target image setting processing according to the first embodiment of the present invention. First, the image sensor 10 photographs the projection plane 200 before the image projection (S11). Then, the photographed image taking-in part 211 acquires the photographed image from the image sensor 10, and outputs it to the projection area setting part 212.

Next, the projection area setting part 212 sets up the projection area and the tolerance based on the received photographed image (S12). The projection area setting part 212 sets up a tolerance value of the difference in projection distance for optical correction, for example, setting up an upper limit and a lower limit of the difference or a ratio of the upper limit and the lower limit. In addition to this, the projection area setting part 212 sets up the tolerance of the difference in region area for the geometric distortion correction (specifically, a ratio of an upper limit and a lower limit of the difference or a ratio of the upper limit and the lower limit), the tolerance of the difference in the resolution (specifically, an upper limit value and a lower limit value of the difference or a ratio of the upper limit and the lower limit), and the tolerance of difference in the luminance (specifically, an upper limit value and a lower limit value of the difference or a ratio of the upper limit and the lower limit). Then, the target image generating part 213 generates the target image (S13). At this time, the target image generating part 213 acquires the grating-like test pattern 231 from the storage part 23 as one for geometric distortion check, and generates the target image so that it may fit in the projection area, for example. FIG. 9 is a diagram showing an example of a target image G30 according to the first embodiment of the present invention. Incidentally, the number of lattices and an interval of the test pattern for geometric distortion check are not limited to the example of FIG. 9.

After the generation, the projection optical system module 50 projects the target image (S14). Here, let it be assumed that the target image generated by the target image generating part 213 is projected by the projection optical system module 50 through the difference analysis part 214, the electrical correction parameter calculating part 216, the image display part 22, and the driver 40. Alternatively, the target image may be outputted to the driver 40, not passing through the image display part 22.

Then, the image sensor 10 photographs the projection plane 200 (S15). At this time, the photographed image taking-in part 211 acquires the photographed image from the image sensor 10, and outputs it to the difference analysis part 214.

Then, the difference analysis part 214 conducts a difference analysis of the target image and the photographed image (S16). Specifically, first, based on each lattice point in the target image, the difference analysis part 214 recognizes corresponding lattice point in the photographed image. That is, the difference analysis part 214 divides the photographed image into a plurality of regions so that they may correspond to respective regions in the target image. Then, the difference analysis part 214 calculates the projection distance for every region of the photographed image. For example, the difference analysis part 214 calculates the relative projection distance of each region by comparing areas of corresponding regions of the target image and the photographed image. Subsequently, the difference analysis part 214 decides a most focused region among the plurality of regions as the focus center. As the focus center, a region having a median among various projection distances of the regions is decided. The difference analysis part 214 outputs information of the decided region to the optical correction parameter calculating part 215. Then, the optical correction parameter calculating part 215 outputs to the optical control part 40 control information for controlling the lens contained in the projection system optical module 50 so that the decided region may become the focus center.

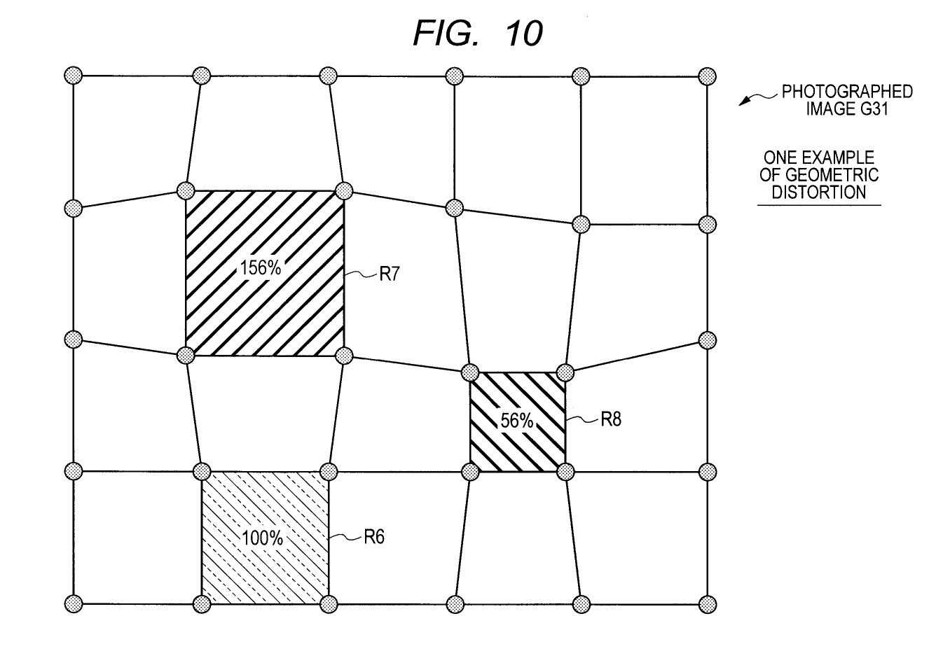

FIG. 10 is a diagram showing an example of a photographed image G31 obtained by photographing the target image G30 projected onto the projection plane 200 with the image sensor 10. A photographed image G31 shows that the geometric distortion occurs as compared with the target image G30. For example, the figure shows that a region R6 has no difference because a ratio of the region size with the target image G30 is 100%. Moreover, the figure shows that a region R7 has a longer projection distance compared to the region R6 because the ratio of the region size with the target image G30 is 156%. On the contrary, the figure shows that a region R8 has a shorter projection distance compared to the region R6 because the ratio of the region size with the target image G30 is 56%. Therefore, the focus center becomes the region R6 among the regions R6, R7, and R8.

Returning to FIG. 4, an explanation will be given. Subsequently, the difference analysis part 214 determines whether the difference in projection distance is within the tolerance (S17). That is, in accordance with the control information received from the optical correction parameter calculating part 215, the optical control part 40 controls the position of the lens of the projection system optical module 50, and decides the focus center. The projection system optical module 50 re-projects the image whose focus center was decided onto the projection plane 200. Then, the image sensor 10 takes in the image whose focus center was decided by photographing it again. Furthermore, the image analysis part 21 takes in the image, and the difference analysis part 214 acquires the image. Then, the difference analysis part 214 calculates a relative projection distance between respective regions of the image whose focus center was decided based on the area of each region of the target image. Moreover, the difference analysis part 214 grasps the display position and the display size of the acquired image. At this time, if a difference in projection distance between respective regions, a display position, and a display size of the projected image are within respective tolerances, the image adjustment processing is terminated. In this case, this is because, since the focus center, the display position, and the display size are decided, the projected image is such that the resolutions have been uniformized within the image. This is because that the relative projection distance seeing from the focus center is within the tolerance means that the focal point is fixed overall the image and it can be considered that the resolution is equally uniformized. On the other hand, when at least one of the differences in projection distance between respective regions of the projected image exceeds the tolerance, the flow proceeds to the optical correction processing. In this case, this is because the resolutions have not been uniformized within the projected image.

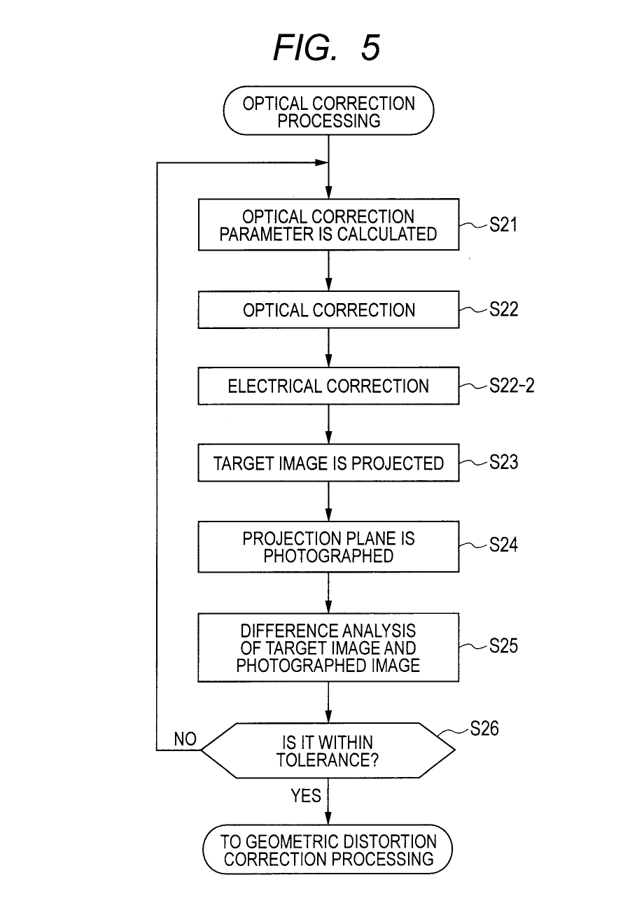

FIG. 5 is a flowchart showing a flow of the optical correction processing according to the first embodiment of the present invention. In the case where at least one of the differences in projection distance between respective regions of the projected image exceeds the tolerance, or in the case where the display position or display size exceeds the tolerance, the optical correction parameter calculating part 215 calculates a shift quantity of the lens of the projection optical system module 50 as an optical correction parameter (S21). Then, the optical control part 30 performs an optical correction in either way of the followings (S22): adjusting the display position and display size in a purely optical manner by shifting the lens of the projection optical system module 50 based on the calculated lens shift quantity; or re-deciding a region that is intended to be the focus center. Next, in this embodiment, at Step S22-2, a processing of electrically correcting a pixel value of the image is also performed like a two-dimensional filter based on the MTF curve described below (S22-2). For example, a case where even if the form of the projection plane is a planar surface, it is huge and the image is displayed being blurred due to limitation of the optical characteristic of the lens used for projection is considered. A range within which the focus of the lens can be obtained differs for every lens because of difference in lens capability. Thereat, the electrical correction parameter calculating part 216 reads the optical characteristic of the lens used in the projection optical system module 50 from the storage part 23. Incidentally, the storage part 23 shall also store the optical characteristic of the lens used in the projection optical system module 50 in advance. As such an optical characteristic of the lens, an MTF curve of the lens is considerable, for example. The MTF curve shows how much degree the resolution of the image projected using a lens portion departing from the center of the lens becomes deteriorated. Then, the electrical correction parameter calculating part 216 calculates a parameter for collecting a pixel value of an image to be projected so that the resolutions of the image may be uniformized even if the resolutions of the image projected according to the MTF curve deteriorates. That is, it will calculate a parameter for correcting the image based on the inverse characteristic of the optical characteristic of the lens. The parameter here referred to is a filter coefficient of a two-dimensional filter applied to the image, for example. Such a two-dimensional filter acts as a two-dimensional filter whose characteristic is closely analogous to the inverse characteristic of the optical characteristic of the lens. The use of this two-dimensional filter makes possible a processing, for example, whereby a line segment whose line width is assumed to be displayed fat because of deterioration in the resolution based on the MTF curve is converted into a line segment with a thinner line width before the projection in advance, and after the projection, the line width of the line segment is made not to grow fat visually. After that, the projection optical system module 50 projects the target image (S23). Then, the image sensor 10 photographs the projection plane 200 (S24). Here, the difference analysis part 214 conducts the difference analysis of the target image and the photographed image, similarly with Step S16 of FIG. 4 (S25).

Following this, the difference analysis part 214 determines whether the difference in the resolution between respective regions of the projected image is within the tolerance (S26). That is, when the difference in the resolution between the respective regions of the projected image is within the tolerance, the flow of the difference analysis part 214 proceeds to the geometric distortion correction processing. This is because when the projection plane contains an uneven portion at least partially, a shape of the projected image is distorted. Moreover, when the difference in the resolution between the respective regions of the projected image exceeds the tolerance, the flow returns to Step S21, where the above-mentioned correction is performed again by altering the coefficient of the two-dimensional filter or by other amendment.

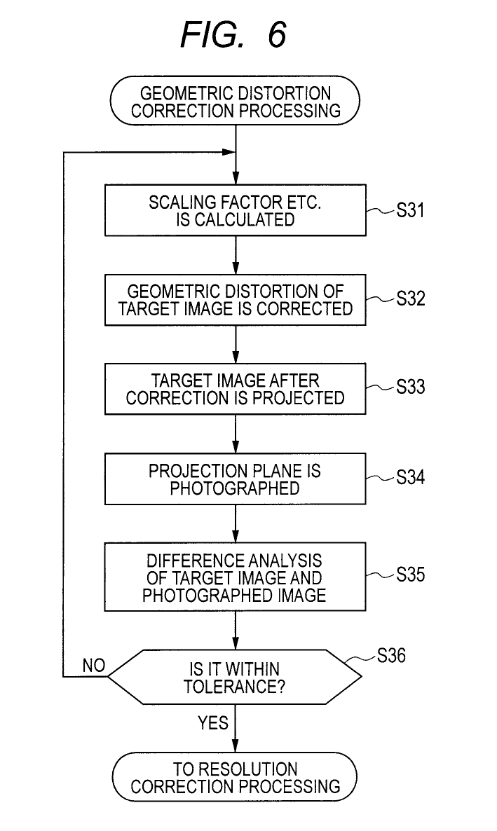

FIG. 6 is a flowchart showing a flow of the geometric distortion correction processing according to the first embodiment of the present invention. First, the electrical correction parameter calculating part 216 calculates a scaling factor etc. (S31). Specifically, the electrical correction parameter calculating part 216 calculates the electrical correction parameter for correcting the geometric distortion correction based on the difference between the regions of the target image and of the photographed image that was analyzed by Step S26 of FIG. 5. As one example of the electrical correction parameter for performing the geometric distortion correction, there is given the scaling factor. In this case, the electrical correction parameter calculating part 216 designates a region where the projection distance is shortest among the regions of the photographed image as a reference region. Then, the electrical correction parameter calculating part 216 calculates a reciprocal of the size ratio of an other region to the reference region as the scaling factor. That is, when the length of the line segment in each region is longer than the length of the corresponding line segment in the region where the projection distance is shortest, the electrical correction parameter calculating part 216 calculates the scaling factor whereby the length of the line segment of the target image is made short. For example, in the case of the photographed image G31 of FIG. 10, the reference region becomes the region R8 where the projection distance is shortest. Then, since the ratio of the length of the line segment of the region R7 to the region R8 in the photographed image G31 is 156%/56%=279%, 36% that is a reciprocal becomes the scaling factor. Moreover, in the case where the geometric distortion occurred by the photographed image is a trapezoid, the electrical correction parameter calculating part 216 calculates a ratio whereby the region is transformed into an inverted keystone.

Next, the image transformation part 221 corrects the geometric distortion of the target image (S32). That is, based on the calculated electrical correction parameter, the image transformation part 221 performs a digital signal processing correction so that the sizes, the display positions, and the shapes of the projected image and the target image become equivalent. For example, the image transformation part 221 corrects the form of the target image based on the scaling factor calculated by Step S31.

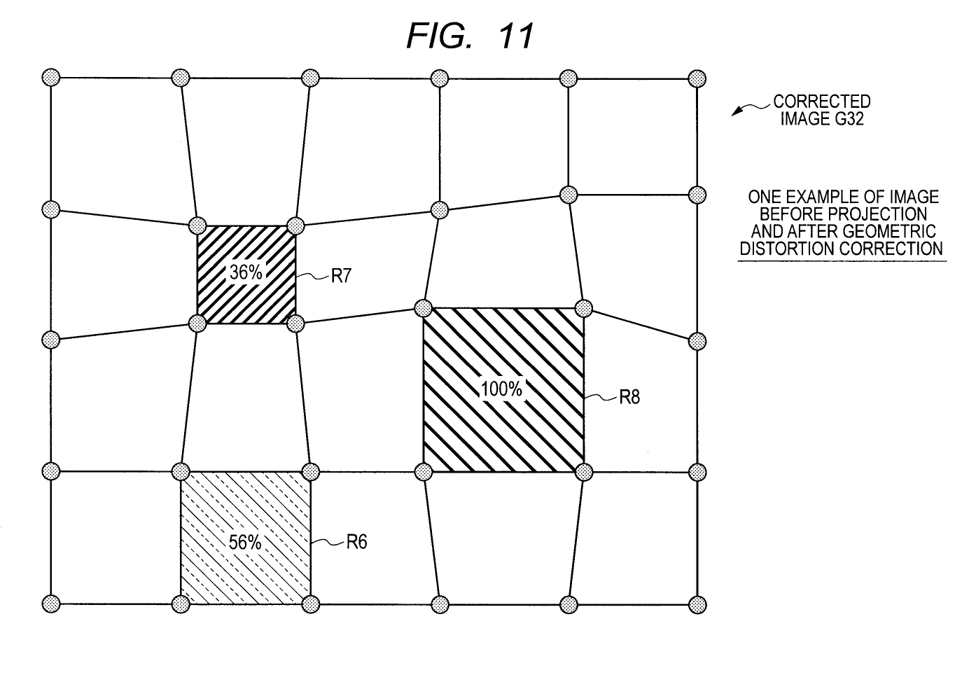

FIG. 11 is a diagram showing an example of the corrected image G32 obtained by geometric distortion correcting the target image G30 according to the first embodiment of the present invention. Here, the scaling is premised that it must be done in a direction of reducing the image. With this premise, the region R8 where the projection distance is shortest and the image size is made small will suffer no reduction in size (size of 100%). Although in the region R6 of the corrected image G32 where the projection distance becomes intermediate, no geometric distortion occurs, it is reduced by the predetermined scaling factor (56%) because the region R8 is specified to be no reduction. Moreover, since in the region R7, the geometric distortion has occurred in the photographed image G31, it is reduced by a still bigger reduction rate (36%) than that of the region R6.

Returning to FIG. 6, an explanation will be given. Then, the projection optical system module 50 projects the target image after the correction (S33). Subsequently, the image sensor 10 photographs the projection plane (S34). Then, the difference analysis part 214 conducts the difference analysis of the target image and the photographed image (S35). In doing this, the difference analysis part 214 calculates the differences in size, display position, and shape (hereinafter, referred to as shape etc.) for every region of the target image and the photographed image.

Following this, the difference analysis part 214 determines whether a difference in the shape etc. is within the tolerance (S36). When the difference in the shape etc. is within the tolerance, the flow proceeds to the resolution correction processing. Moreover, when the difference in the shape etc. exceeds the tolerances, the flow returns to Step S31. Incidentally, in the case where the difference in the shape etc. is within the tolerance, the photographed image becomes a generally equivalent image as the target image, and therefore illustration of the photographed image photographed at Step S34 is omitted.

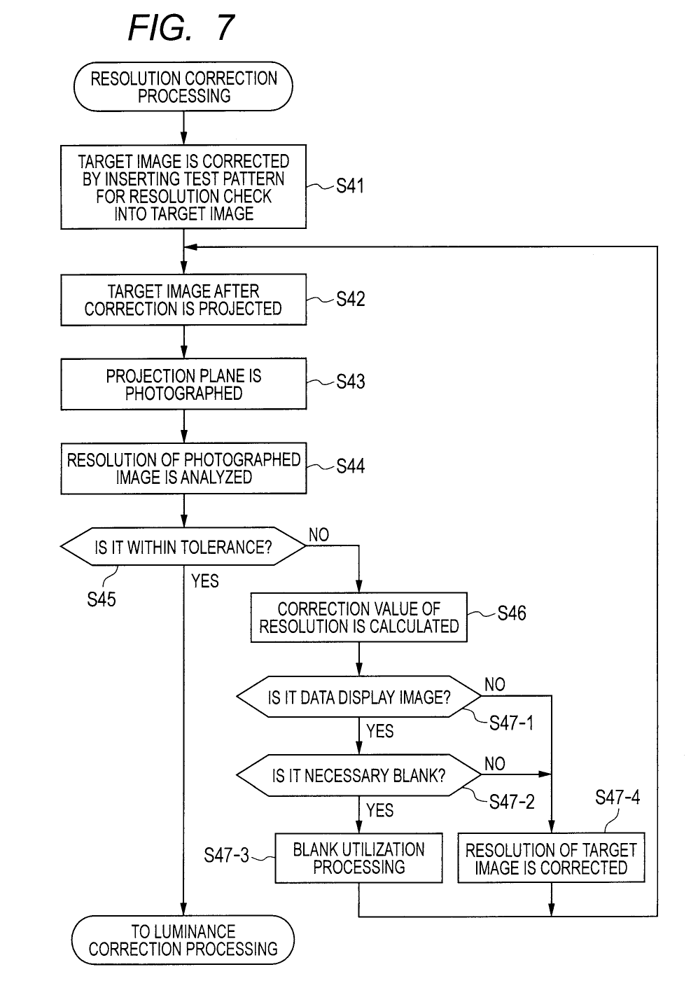

FIG. 7 is a flowchart showing a flow of the resolution correction processing according to the first embodiment of the present invention. First, the image transformation part 221 corrects the photographed image by inserting a test pattern for resolution check into the target image (S41). For example, the image transformation part 221 inserts the test pattern for resolution check into the target image generated at Step S13. After that, the image transformation part 221 may update the target image by performing the geometric distortion correction equivalent to that of Step S32. Thereby, ununiformity in the resolution within the region can be detected. Here, the test pattern for resolution check shall contain at least two or more lines per region. This is for consideration of a frequency characteristic. Incidentally, here in order to make it easier to understand, adjustment of the resolution is explained taking the test pattern as shown in FIG. 12 as an example. However, it is all right to project an image inputted from the signal generator 300, for example, a still image and a moving image, onto the projection plane 200, perform the above-mentioned geometric distortion correction by photographing the image that was projected, and perform an adjustment of the resolution to the image being geometric distortion corrected, and in this case the following processing can be applied.

FIG. 12 is a diagram showing an example of a target image G33 after the updating obtained by inserting a test pattern Ti for resolution check into the target image G30 according to the first embodiment of the present invention. The test pattern T1 is a pattern represented by three straight lines of the same thickness in each region. Here, in order to be able to give an explanation using a more concrete example, let it be assumed that each line is drawn in a perpendicular direction, having a larger number of pixels than on pixel, for example, having a width of three pixels. That is, FIG. 12 shows the pattern such that three line segments each with a width of three pixels are drawn within each lattice. Incidentally, an example of the test pattern for resolution check is not limited to this. Moreover, in this case, the image transformation part 221 will perform a similar geometric distortion correction as that of Step S32 further on the target image G33.

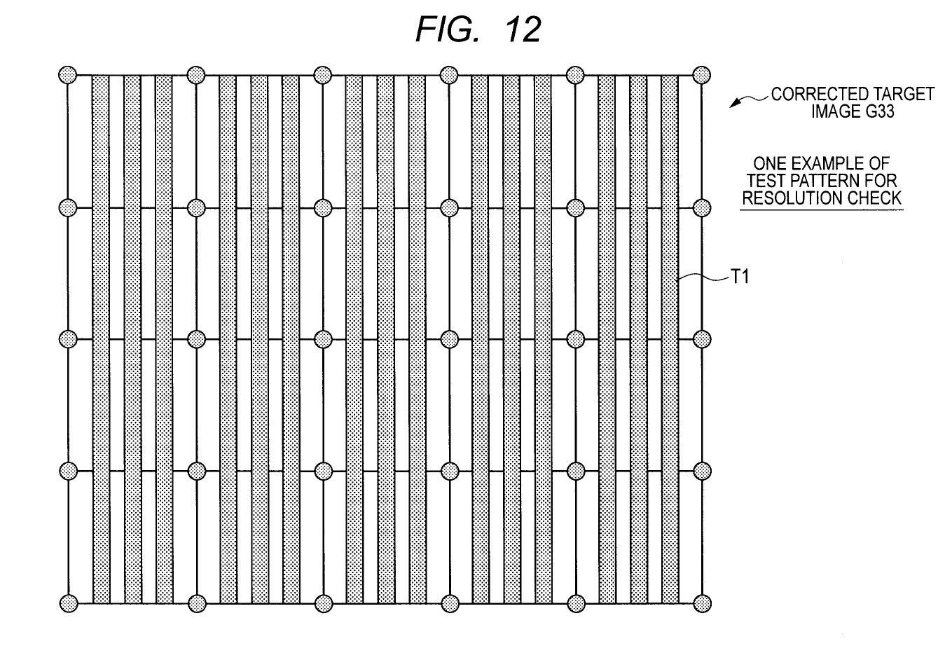

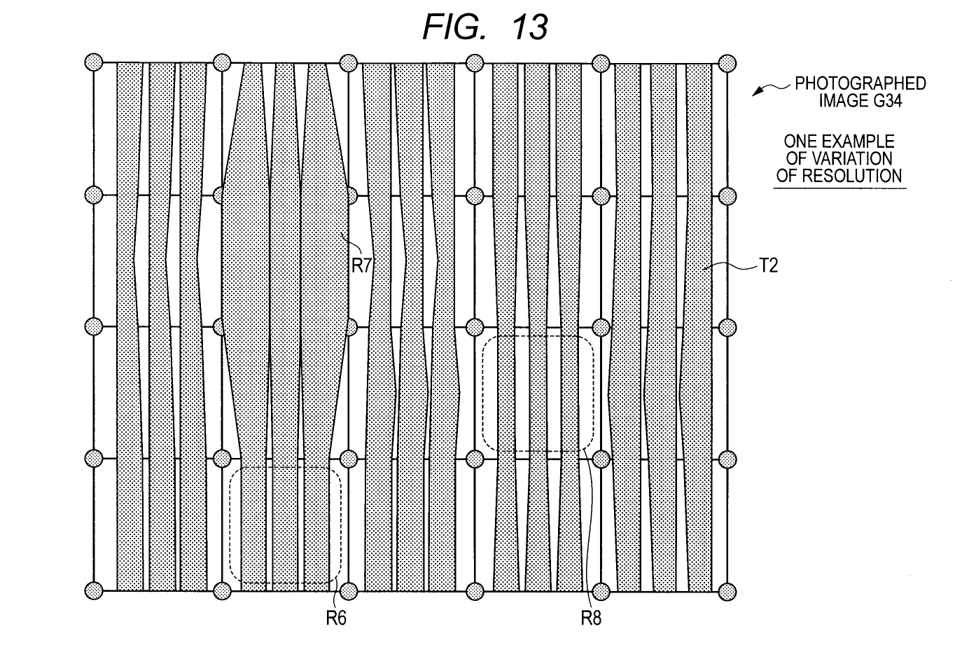

Returning to FIG. 7, an explanation will be given. Next, the projection optical system module 50 projects the corrected target image after performing the geometric distortion correction on the target image G33 (S42). Then, the image sensor 10 photographs the projection plane 200 (S43). FIG. 13 is a diagram showing an example of the variation in the resolution of the whole image according to the first embodiment of the present invention. The photographed image G34 and the test pattern T2 of FIG. 13 are an example of a display result on the projection plane formed by projecting the test pattern T1 after being geometric distortion corrected. The figure shows that each line of the test pattern T2 is corrected generally in a vertical direction, but the thickness of the line is different in each region and within the region.

FIG. 13 shows that a width of the line segment becomes thicker for the grating that is geometric distortion corrected and there is a portion where the line segments do not overlap each other (for example, the region R6). This is a case where a shape of the grating is at least partially reduced as to be a trapezoidal shape by the keystone distortion correction, and as a result the shape is reduced to a width of one pixel that is a minimum unit although it originally needs to be reduced to a width smaller than the width of one pixel that is a minimum line width because of a relationship of difference seeing from the projection distance minimum (with no resizing) area, and even when the grating is reduced, the line segments do not overlap each other. For example, a case where the grating is reduced to a keystone shape is considered. Then, a case where its lower base is reduced while the length of its upper base remains in the length of the line segment before the reduction is considered concretely. Since the number of pixels usable in representation of the line segment reduces in the lower base, as much as three pixels no longer can be used in order to represent one line segment. Therefore, a situation becomes that although in the upper base, three pixels represent one line segment, in the lower base, one pixel must represent the width of one line segment. Here, in this example, let it be assumed that the three line segments whose starting points are three pixels in the upper base of the trapezoidal grating have separate three pixels in the lower base as their end points, respectively. That is, let it be assumed that the line segments do not overlap each other also in the lower base that is reduced most in this grating. However, if based on the difference seen from the projection distance minimum (with no resizing) region, let it be assumed that the line width must be narrowed further than the width of one pixel when the size of the grating is reduced. In that case, although the interval among three line segments in the lower base becomes relatively narrower than the interval of the three line segments in the upper base, in this example, the line segments do not overlap each other also in the lower base. In this situation, even if the projection optical system module 50 re-projects the image after being geometric distortion corrected onto the projection plane 200, its line width will grow thicker than the line width of FIG. 12, as is illustrated in FIG. 13. That is, originating from a fact that the line width was not able to be reduced to a proper width sufficiently, the line will be displayed as a line segment with a width having gotten fat to be larger than the width that should be displayed originally. In this example, since three line segments will be displayed on the projection plane 200 in a state of being distinguished clearly although they have gotten fat in width, the line segments will be able to be represented properly with a resolution deteriorated by the grating being reduced.

On the other hand, in FIG. 13, there exists a grating such that its line width grew fat, and the line segments are overlapped each other and are fit in with black partially (for example, the region R7). This is because the resolution of the grating of the projected image has fallen below the resolution required in order to display the three line segments each having a width of three pixels in one lattice shown in FIG. 12. The patterns in which this result is displayed in the projection image are the following two: a case where although the line segments do not overlap each other at the time of reducing the grating in the image before the projection, the line segments grow fat thicker than the original line width and overlap each other similarly with the above-mentioned content; and a case where the line segments have already overlapped each other in the image before the projection. In either case, in the image projected onto the projection plane 200, the line segments overlap to be painted over with black or gray. That is, FIG. 13 shows a situation where the resolution has become different in each part of the projected image, namely in each region, as a result of having performed the geometric distortion correction.

Returning to FIG. 7, an explanation will be given. Subsequently, the difference analysis part 214 analyzes the resolution of the photographed image (S44). At this time, the difference analysis part 214 calculates the resolution and the luminance based on the projection distance, the region size, the number of pixels, etc. for every region of the photographed image. Moreover, the difference analysis part 214 calculates the difference in the resolution for every region that the photographed image has. Specifically, the difference analysis part 214 will calculate the resolution of every region by increasing the number of the line segments per unit area for every region, and detecting how many number of line segments can be displayed through repetitive projection and photographing. Through this processing, it is possible to specify a region where the resolution has becomes lowest in the photographed image, and to calculate how much degree the resolution is good seeing from the region whose resolution has fallen lowest. In addition, the difference analysis part 214 calculates the difference in the luminance between the regions of the photographed image. Also here, it is possible to specify a region whose luminance becomes lowest in the photographed image, and further to calculate how much degree the luminance is good in the other region seeing from the region whose luminance becomes lowest.

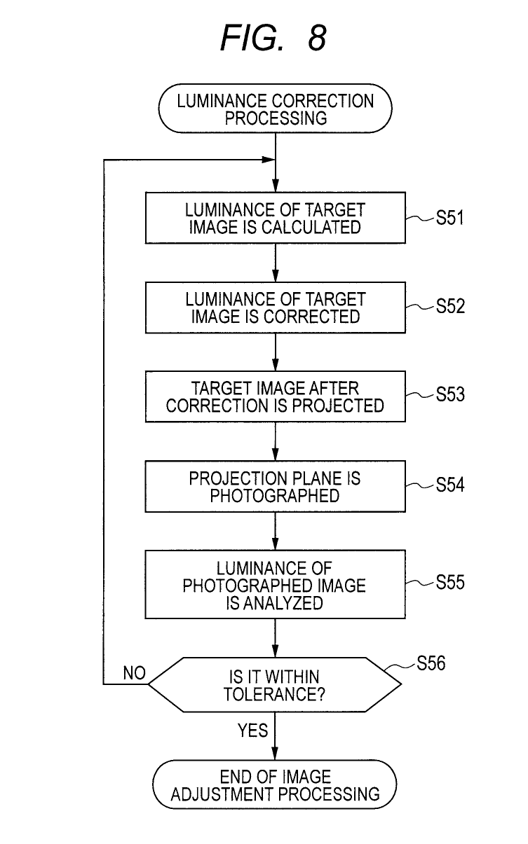

Following this, the difference analysis part 214 determines whether each of the differences between the resolution of the region where the resolution becomes lowest in the photographed image and the resolution of the other region falls within the tolerance (S45). If all the differences in the resolution between the region where the resolution falls lowest and the other regions fall within the tolerance, it will means that the resolutions are uniformized in the image. Therefore, if the image is re-projected onto the projection plane 200 in this situation, the image will be projected in a good image quality on human vision because the resolutions are uniformized. Therefore, in this case, the flow proceeds to the luminance correction processing (FIG. 8) next. On the other hand, if at least a part of the differences in the resolution between the region where the resolution falls lowest and the other respective region exceeds the tolerance, the resolutions are not uniformized within the image. If the image is projected onto the projection plane 200 as it is, the resolution varies for every region of the projected image, the image quality deterioration will become notable on human vision. Then, the flow proceeds to the next Step S46 in this case.

At Step S46, the electrical correction parameter calculating part 216 calculates the correction value of the resolution (S46). The correction referred to here is a value that is required for the correction to be performed on such a projected image in order to cancel the ununiformity in the resolution of the image projected onto the projection plane 200. For example, this correction value is a ratio as to how many pixels representing the blanks are eliminated and how many pixels are converted into pixels for thickening the line width. Here, in the case where the image is not a natural picture but a data displaying image of a text, a symbol, etc. and the blanks that cause no problem even if being eliminated exist in the image, the resolution conversion part 222 performs the blank utilization processing. The data display image termed here shall refer to an image on which text data, such as a character, a numerical value, and a symbol, timetables, etc. are displayed. Therefore, the data display image can be said as an image that causes no problem in display contents even if the blank is eliminated. On the other hand, a natural image referred to here shall include all images except the above-mentioned data display images, not being limited to images of scenery, persons, etc. Then, in the blank utilization processing, the resolution conversion part 222 decides how much degree the blanks are cut and how many magnification the line width is thickened and applies the magnification all over the image uniformly. Here, let it be assumed that the line width of the projected image is uniformly thickened three times. In this case, the blanks are eliminated for all the line segments within the projected image, and the line width is changed to three times thickness uniformly. For example, a pattern with a line width of three pixels will be drawn with the line width of nine pixels. By such drawing, the pattern that can be represented without the line segments overlapped because of being a region having an excellent resolution temporarily is now represented as a thickened line in some cases, or represented as overlapped line segments in some cases. That is, the resolution of the whole image is deteriorated uniformly by the same ratio. In the case where the uniformity condition of the resolution of the image does not fit in the tolerance even by converting it by the above-mentioned magnification, the above-mentioned magnification will be altered and the feedback processing will be executed until the resolution is fit in the tolerance.

However, the above-mentioned blank utilization processing can only be performed in the case where the image is not a natural picture but a data displaying image, and a blank that can be eliminated without causing a problem exists in the image. Because of this, at Step S47-1 of FIG. 7, the resolution conversion part 222 checks whether the image is the data displaying image (S47-1). If the image is the data display image, the resolution conversion part 222 will check whether a blank necessary in order to make the line width grow fat at a desired magnification uniformly within the image exists (S47-2). If there is the blank, the resolution conversion part 222 will perform the blank utilization processing (S47-3). On the other hand, in the case where it is determined that the image is not the data display image at Step S47-1, or in the case where it is determined that the necessary blank does not exist at Step S47-1, it cannot perform the blank utilization processing, and therefore it performs a filter processing that will be described below. The processing whereby the resolution conversion part 222 increases the line width of the other regions is not used for representing the line width concretely, but it replaces the pixel value of the pixel representing the blank with a pixel value required for representing the line width. For example, it is realized by altering a luminance level into black from white.

As described above, when the blank utilization processing is not able to be performed, the filter coefficient is calculated as another correction value. For example, in a stage of performing the geometric distortion correction, there occurs a compression processing whereby the size ratio is reduced from 1000 (e.g., 100 pixels in the unit region) to 80% (80 pixels in the unit region) for one lattice. In the reduction processing like this, a scaling filter processing is performed on the image to reduce the resolution. In the case where the number of pixels representing an object is reduced like the above-mentioned case where the line segment of a width of three pixels is converted into a line segment of a width of one pixel, an operation whereby the pixel values of the respective pixels are averaged by weighting and adding them with the filter coefficients is performed. For example, the pixel values of three pixels are averaged by weighting and adding them with the filter coefficients to find a new pixel value. Then, the new pixel value thus obtained is applied to one pixel for representing a line segment after the reduction, and the remaining two pixels are not used as pixels that are made not to emit light. By this processing, three pixels are changed into one pixel, for example. The compression processing is a filter processing like this after all, and a scaling filter coefficient is used. Then, the electrical correction parameter calculating part 216 specifies the filter coefficient used in the reduction processing performed on any one of the lattices. Subsequently, the resolution conversion part 222 corrects the resolution of the target image (S47-4). Specifically, the resolution conversion part 222 applies the filter processing that uses this specified filter coefficient to other regions. However, since this processing doe not reduce the image here, it does not reduce the number of pixels. However, a pixel value of a certain one pixel is averaged together with pixel values of surrounding pixels by weighting and adding them with the scaling filter coefficient, and the correction is performed. The pixels of the region whose resolution should be corrected are subjected to such a filter processing and the pixel values are corrected. Moreover, if after the resolution is deteriorated using the specific filter coefficient once, the uniformity degree of the resolution does not fall within the tolerance, the following procedure will be repeated: the filter coefficient is changed to one that deteriorates the resolution more, and the resolution of the image is re-deteriorated. In a stage where a uniformity condition of the resolution of the image falls within the tolerance, this feedback processing is terminated. As a result, the images of respective regions are corrected in a direction of blurring when being projected.

The projection optical system module 50 re-projects the image corrected by the above-mentioned filter processing onto the projection plane 200, and the image sensor 10 re-photographs it (returning to Steps S42 and S43). Then, similarly with the above-mentioned Step S44, the difference analysis part 214 calculates the resolutions of respective regions of the photographed image. It is re-determined whether the difference in the resolution between the region whose resolution has become lowest by the geometric distortion correction and the other region is within the tolerance (S44).

Here, if the difference is within the tolerance, the resolutions of the respective regions of the projected image will have been uniformized by the above-mentioned filter processing. If the difference is not within the tolerance, Step S46 and subsequent steps will be repeated again. In doing this, the coefficient of the scaling filter is altered, so that the difference may fall within the tolerance.

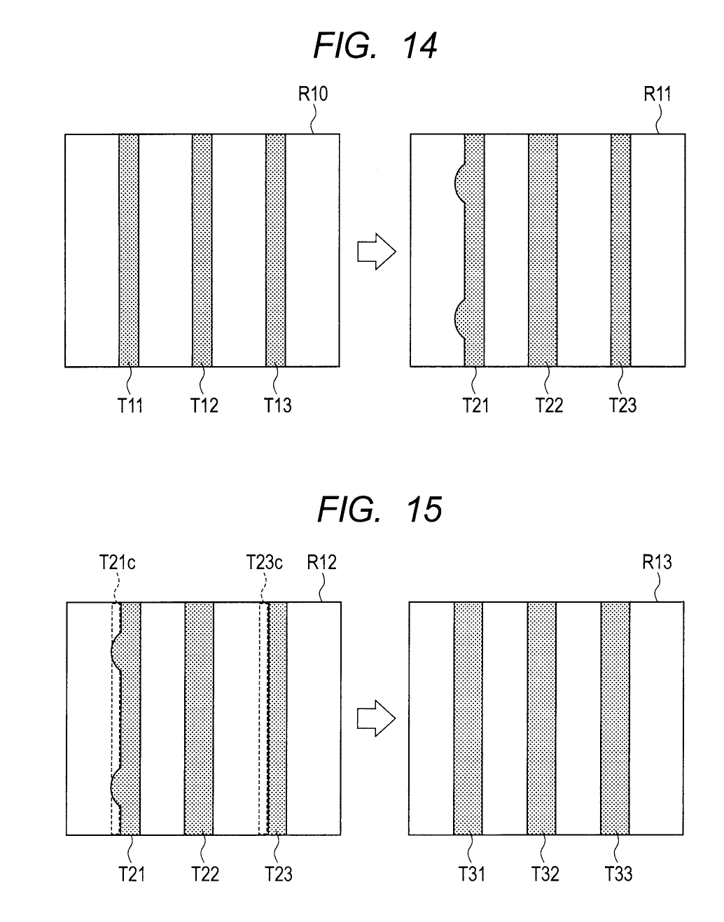

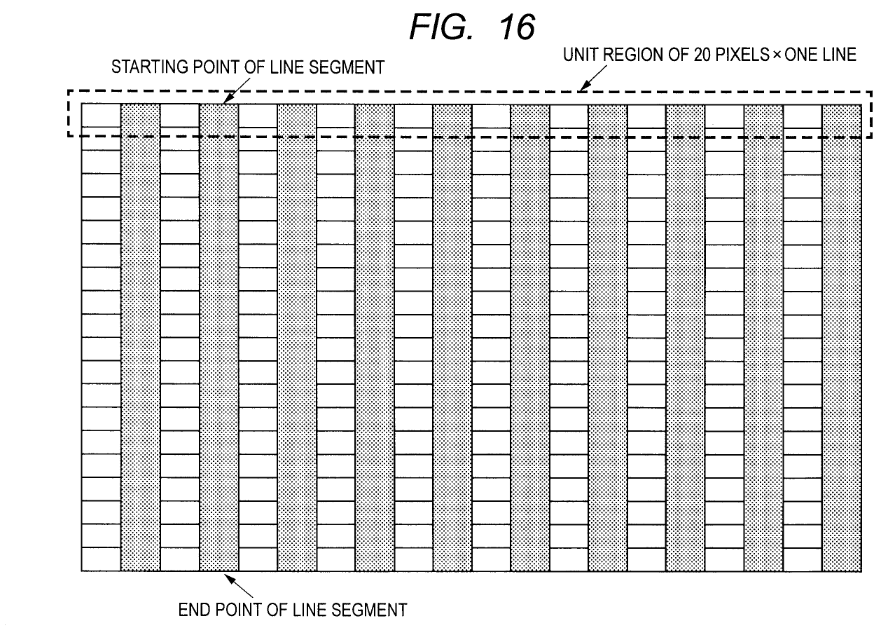

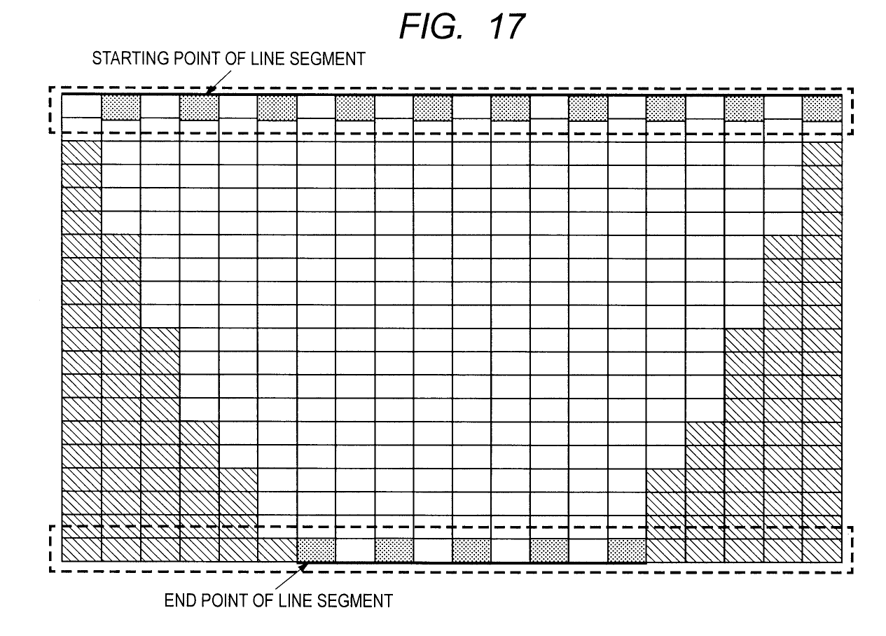

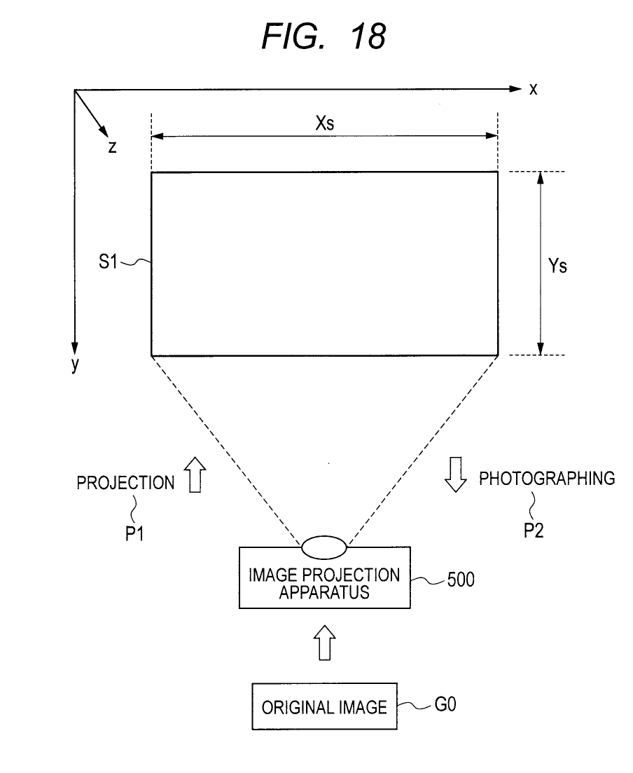

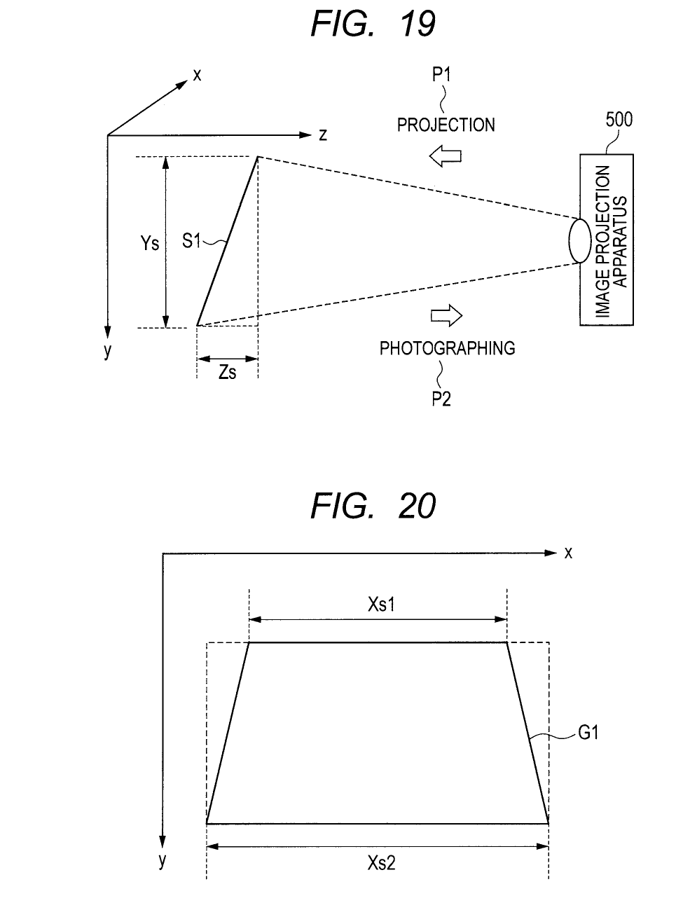

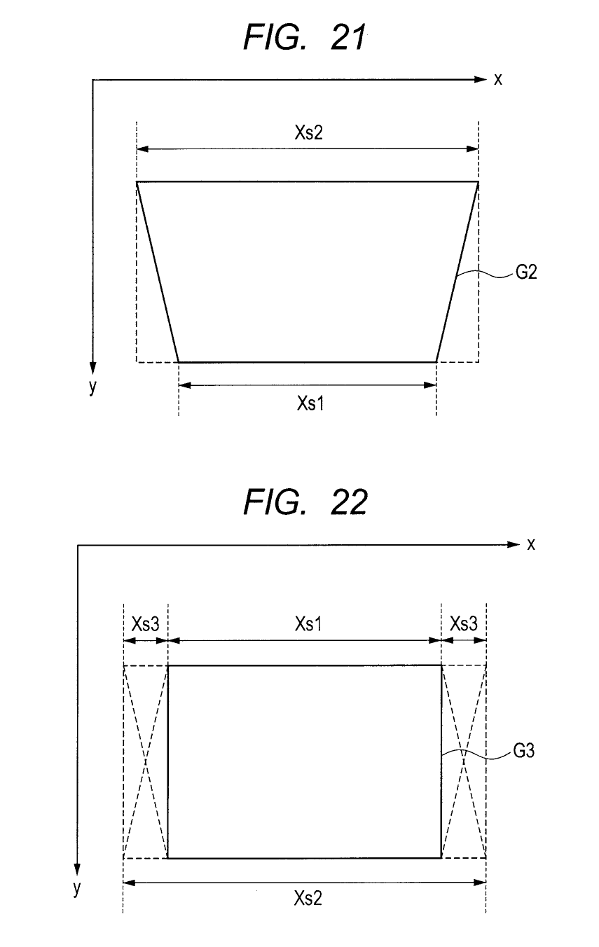

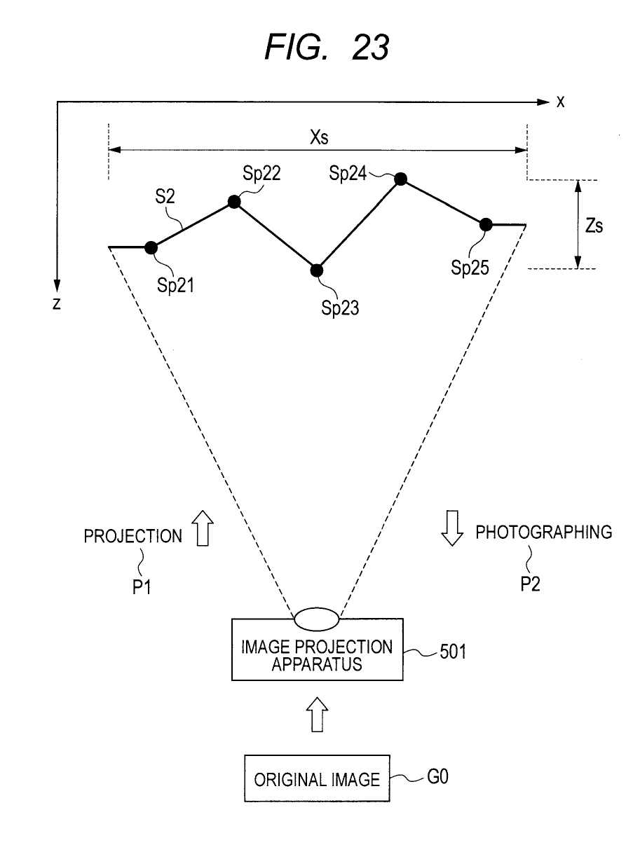

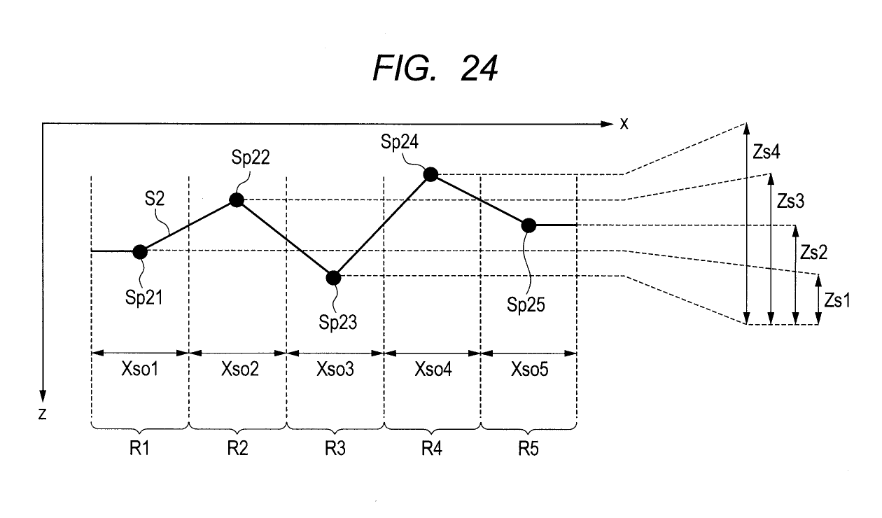

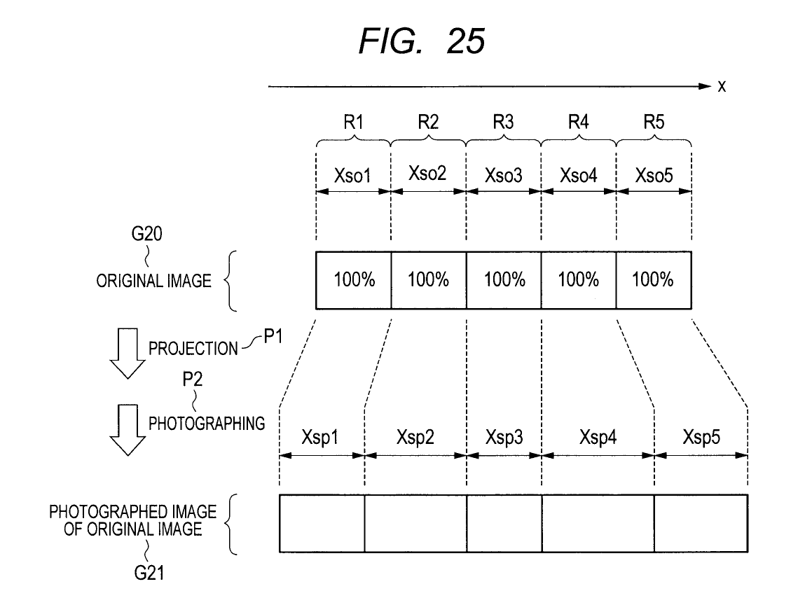

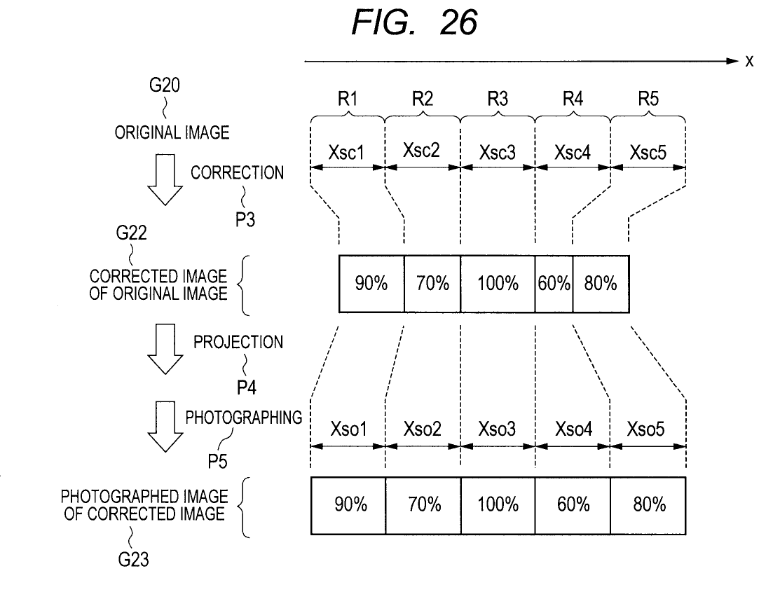

Here, in order to understand the above-mentioned blank utilization processing more concretely, it will be explained using FIG. 14 and FIG. 15. In FIG. 14 and FIG. 15, three partial images of an identical shape are used as a test pattern in an arbitrary region, and how to correct the variation in the resolution that occurs when the geometric distortion correction is performed on these are explained.

FIG. 14 is a diagram showing an example of variation in the resolution within the region according to the first embodiment of the present invention. A region R10 indicates an arbitrary region in the target image. Then, the region R10 includes test patterns T11 to T13. The test patterns T11 to T13 are three partial image test patterns each of an identical shape. A region R11 is a region corresponding to the region R10 in the photographed image whose target image is subjected to the geometric distortion correction, the projection, and the photographing. The region R11 contains test patterns T21 to T23. The test patterns T21 to T23 show that the variation in the resolution is occurring, although the test patterns T11 to T13 were geometric distortion corrected, respectively. Here, the test pattern T21 has a partial bulge, showing that the resolution differs in the vertical direction. The figure shows that although a test pattern T22 has a generally uniform resolution in a vertical direction, the line is thick compared with a test pattern T12. The figure shows that the test pattern T23 has a line width generally equivalent to that of the test pattern T13, and the resolution is also generally uniform. Here, for example, let it be assumed that the region R11 contains the test pattern T22 whose resolution becomes lowest in the image projected onto the projection plane 200.

Here, the case where the line becomes thick by the geometric distortion correction compared with a situation before the correction means that the pixels are reduced in number by the geometric distortion correction and the resolution falls compared with the situation before the correction. In this case, for example, a thick portion of the line will be seen being blurred to human eyes. That is, compared with the test pattern T23, the test pattern T22 is unclear and, and the test pattern T21 is seen unclear partially.

Then, as the resolution correction processing according to the first embodiment of the present invention, it is desirable that the image display part 22 corrects the resolutions of the other regions so that they may approach the resolution of the region when there exists the region such that the size of the partial becomes large as compared with the partial image before the correction in the photographed image after the image that was geometrical distortion corrected was projected. Thereby, although the resolution of the whole image becomes low, the resolution of the whole image is uniformized. Since the ununiformity in the resolution has a largest influence on unnaturalness in human eyes, the fall of the resolution can be ignored even if it becomes lower than the resolution of the target image. Therefore, consequently, it is possible to provide a reasonable image quality.

FIG. 15 is a diagram showing an example of the corrected image that has subjected to correction of the resolution in the region according to the first embodiment of the present invention. A region R12 indicates a part where the resolution of the region R11 is to be corrected. That is, the figure shows that a test pattern T21c is added to the test pattern T21 by correction of the resolution. Moreover, the figure shows that a test pattern T23c is added to the test pattern T23 by correction of the resolution. The figure shows that by conducting such corrections, the thicknesses of lines of test patterns T31 to T33 become generally equivalent and the resolution is uniformized as in a region R13. In the case where the line segments having the same width as that in the region R10 of FIG. 10 are drawn in other regions of the image projected onto the projection plane. their line widths are corrected so that each of the line segments in the other regions may have the thickness of the test pattern T22. Thus, the resolutions of the image projected onto the projection plane 200 are uniformized. Moreover, based on the resolution of this region R11, other patterns drawn in other regions are corrected so that they may become patterns based on the resolution of the region R11.

Incidentally, as another cause of the deterioration in the image quality that is the problem described above, there is given a fact that the luminance of the image after the correction of the geometric distortion becomes ununiform. There are two causes by which the luminance becomes ununiform. A first cause is that in the projection plane having the uneven form at least partially, for example, in the projection plane 200 having the uneven surface, each projection point will have a different reflectance according to the depth of the uneven surface. A second cause is that depending on the focus characteristic of the lens, the luminance tends to deteriorate as the distance from the focus center becomes far. Therefore, only with the geometrical distortion correction described above, the brightnesses of the respective regions remain different, and there is a case where the image looks like a clouding pattern to human eyes. Therefore, how the image is seen to human being may become unnatural also in respect of brightness. Thereat, in the first embodiment of the present invention, the deterioration in the image quality can be suppressed further by the following luminance correction processing.

FIG. 8 is a flowchart showing a flow of the luminance correction processing according to the first embodiment of the present invention. First, the electrical correction parameter calculating part 216 calculates a correction value of the luminance (S51). Specifically, the electrical correction parameter calculating part 216 calculates the electrical correction parameter for correcting the luminance based on the difference in the luminance between the regions of the photographed image analyzed by Step S44 of FIG. 7. Next, the gain adjusting part 223 corrects the luminance of the target image (S52). Specifically, the gain adjusting part 223 corrects the luminance of each region of the image using a gain that is a reciprocal of the reflectance for each projection area with respect to the first cause. Then, the gain adjusting part 223 adjusts the luminance level of each pixel of the target image on the basis of the luminance that is darkest with respect to the second cause. That is, this is because the luminance is highest at the focus center while the luminance is darkest at the projection distance that is most separated from the projection distance of the focus center. By this adjustment, correction intensity of the filter becomes larger as departing from the projection distance of the focus center, and therefore it is possible to bring the luminance of the whole projection area close to uniformity. That is, the image quality can be enhanced.

Then, the projection optical system module 50 projects the target image after the correction (S53). Subsequently, the image sensor 10 photographs the projection plane 200 (S54). Then, the difference analysis part 214 analyzes the luminance of the photographed image (S55). At this time, in the same way as the above-mentioned technique, the difference analysis part 214 calculates the luminance based on the projection distance, the region size, the number of pixels, etc. for every region of the photographed image. Moreover, the difference analysis part 214 calculates the difference in the luminance between the regions of the photographed image.

Following this, the difference analysis part 214 determines whether the difference in the luminance is within the tolerance (S56). If the difference in the luminance is within the tolerance, the image adjustment processing will be terminated. Moreover, if the difference in the luminance exceeds the tolerance, the flow will proceed to Step S51.

Thus, in the first embodiment of the present invention, by acquiring and analyzing the resolution and the luminance of the image that is actually projected and photographed, the projection information in each region within the photographed image is calculated and filter correction whose characteristic is exactly the same as the optical characteristic of the projection lens is performed. Therefore, even if the projection plane is in a whatever form (curved surface, uneven surface, etc.), it is possible to uniformize the resolution (focus characteristic).

Moreover, even when unevenness of the projection plane is fine, it becomes possible to uniformize the resolution (focus characteristic) with the same processing by increasing the number of pixels of the image sensor, by making accuracy of the pixels of correction finer, by increasing the number of pixels of the projector, or by a similar modification.

Furthermore, since the feedback processing is performed by detecting the difference between an actual photographed image and the target image after the correction, it becomes possible to manage correction accuracy.

From the above, according to the present invention, it is possible to uniformize the resolution of the projected image without depending on the form of the projection plane. Still furthermore, as accompanying means, it is also possible to uniformize the luminance of the projected image without depending on the form of the projection plane. Thereby, for example, in the case where a still image is projected, the system can prevent a case where variation in the resolution occurs for each region of the projected still image, and how the image is seen to the human being becomes unnatural. Specifically, it is possible to prevent a state where a pattern drawn in a similar finesse in a certain photograph comes out clearly in a certain portion and comes out being blurred in an other portion. Moreover, it is also possible to prevent a case where, for example, when the moving image in which an object having a fine pattern moves is projected, the fine pattern that comes out clearly on a certain portion on the screen at a certain time comes out being blurred on an other portion on the screen at a different subsequent time, resulting in an obviously unnatural display of the moving image. That is, the image projected onto the projection plane is uniformized in resolution and luminance within the image, and as a result it will be displayed with an excellent image quality on human vision.

### <Other Embodiment of Present Invention>

Incidentally, the target image generating part 213 may use the input signal from the signal generator 300 as the target image for geometric distortion check and for resolution check, as described above, without using the test pattern 231.

Moreover, improvement can be added to the first embodiment of the present invention as follows. For example, a test pattern is made of invisible light, and the image sensor is made to be a photosensor corresponding to wavelengths of the invisible light region. This makes it possible to regularly correct shifts in size, focus, or geometrical distortion caused by an aging variation, a temperature change, a physical movement of the projector and the projection plane, or the like even at the time of usual image projection.

Moreover, as an application object of the first embodiment of the present invention, there is given a display system predicated on projection onto a screen, such as the front projector. That is, this can also be said also as an installation free function for front projector.

Moreover, by using the image projection system 100 according to the first embodiment of the present invention, it is possible to project a video or image onto a location where its installation is impossible hitherto as the projection area. For example, as the projection plane having a wall pattern, there are enumerated a living room of a home or a room of an individual person; as the projection plane having unevenness or a curved surface, there are enumerated walls of a museum, an art gallery, a retail shop, or a floor in a building and the like. Therefore, it is expected that utilization in various uses, such as interior, toys, signage or art, and a utilization method rich in novelty and creativity will be born in addition to home theaters, meetings or presentations in offices, etc. that are preexisting usage.

Moreover, usually, in order to make a focus on a discontinuous and large-screen projection plane, an expensive lens was needed and a distance from the projection plane was required considerably. However, it becomes also possible to produce a projector of a short focus to a discontinuous and large-screen projection plane using a cheap lens by using the first embodiment of the present invention. Furthermore, not in the case of a special projection plane, such as an uneven surface and a curved surface, when the image is projected in a short focal distance and to have a large size image, large deviations occur in the projection distance and in a projection direction within a display area. The present invention is applicable to all of such cases where large deviations occur in the projection distance and in the projection direction.

Incidentally, components of the image projection system 100 according to the first embodiment of the present invention do not need to be devices physically made into one piece, but may be individually independent devices.

FURTHERMORE, IT IS NATURAL THAT THE PRESENT INVENTION IS NOT LIMITED TO THE ABOVE-MENTIONED EMBODIMENTS, AND VARIOUS MODIFICATIONS ARE POSSIBLE WITHIN A LIMIT THAT DOES NOT DEPART FROM A GIST OF THE PRESENT INVENTION ALREADY DESCRIBED.

What is claimed is:

1. An image projection system that projects an image from its lens and projects the image onto a projection plane, and if resolutions in regions of the image projected onto the projection plane are not uniform among the respective regions, corrects each of the resolutions of the image in each region based on an inverse characteristic of an optical characteristic of the lens and projects the image onto the projection plane.

2. An image projection system, wherein, when a resolution of one region of an image gets lower than resolutions of other regions by projecting the image onto a projection plane so that a shape of the image may not be distorted, the image projection system projects an image whose resolutions are deteriorated so that the resolutions of the other regions may become substantially the same as the resolution of the one region.

3. The image projection system, according to claim 2,
wherein the one region is a region whose resolution gas fallen to the lowest level in the image projected onto the projection plane.

4. The image projection system according to claim 2,
wherein the resolutions of the other regions are deteriorated by correcting the pixel values of pixels that the other regions contain using a filter coefficient used for the image being projected so that a shape of the image may not be distorted.

5. A semiconductor integrated circuit for outputting an image whose resolution is deteriorated so that resolutions of other regions may become substantially the same as a resolution of one region when the resolution of the one region of the projected image falls lower than the resolutions of other regions by projecting the image onto a projection plane so that a shape of the image may not be distorted.

6. An image projection system, comprising:
a projection part for projecting a target image onto a projection plane;
a photographing part for photographing the projection plane onto which the target image is projected;
an analysis part for analyzing a photographed image that is an image obtained by photographing the projection plane; and
a correction part for correcting the target image based on an analyzed result;
wherein the analysis part divides the photographed image into a plurality of regions and calculates the resolution for every region when a difference in shape between the target image and the photographed image is within a predetermined range,
wherein the correction part generates a first corrected image from the target image so that the resolutions among the regions may become uniform, and
wherein the projection part projects the first corrected image onto the projection plane.

7. The image projection system according to claim 6,
wherein the analysis part calculates the luminance for every region when a difference in resolution between the regions in the photographed image is within the predetermined range,
wherein the correction part generates a second corrected image from the first corrected image so that the luminances among the regions may become uniform, and
wherein the projection part projects the second corrected image onto the projection plane.

8. The image projection system according to either claim 6,
wherein the analysis part calculates a difference of the shape between the photographed image and the target image,
wherein the correction part generates a third corrected image by correcting the geometrical distortion of the target image based on the difference in the shape when the difference in shape is outside the predetermined range,
wherein the projection part projects the third corrected image onto the projection plane,
wherein the analysis part calculates the resolution for every region in the photographed image when the difference in the shape between the photographed image and the target image is within the predetermined range, and
wherein the correction part generates the first corrected image based on the third corrected image.

9. The image projection system according to claim 8,
wherein the target image includes a plurality of partial images of an identical shape, and
wherein the correction part generates the first corrected image by correcting the resolutions of the other regions so that the resolutions thereof may approach the resolution of the region, when the photographed image is photographed from the projection plane onto which the image is projected after the correction of the geometrical distortion, there exists a region containing the partial image whose size becomes large as compared with the partial image before the correction.

10. The image projection system according to claim 6,
wherein the projection plane has an uneven surface, and
wherein the correction part generates the first corrected image so that the resolutions among the regions may become uniform according to the uneven surface.

11. A semiconductor integrated circuit, comprising:
an analysis part for analyzing a photographed image that is an image obtained by photographing a projection plane onto which a target image is projected; and
a correction part for correcting the target image based on an analyzed result;
wherein the analysis part divided the photographed image into a plurality of regions and calculates a resolution for the every region when a difference in shape between the target image and the photographed image is within a predetermined range, and the correction part generates a first corrected image from the target image so that the resolutions among the regions may become uniform and projects the first corrected image onto the projection plane.

12. The semiconductor integrated circuit according to claim 11, wherein the analysis part calculates the luminance for every region when a difference in resolution between the regions in the photographed image is within the predetermined range, and
wherein the correction part generates a second corrected image from the first corrected image so that the luminance among the regions may become uniform and projects the second corrected image onto the projection plane.

13. The semiconductor integrated circuit according to claim 11,
wherein the analysis part calculates a difference in shape between the photographed image and the target image,
wherein the correction part generates a third corrected image by correcting distortion of the shape of the target image based on the difference in the shape, when the difference in the shape is outside the predetermined range, and makes the third corrected image project onto the projection plane,
wherein the analysis part calculates the resolution for every region in the photographed image when the difference in the shape between the photographed image and the target image is within the predetermined range, and
wherein the correction part generates the first corrected image based on the third corrected image.

14. The semiconductor integrated circuit according to claim 13,
wherein the target image contains a plurality of partial images of an identical shape, and
wherein the correction part generates the first corrected image by correcting the resolutions of other regions so that they may approach the resolution of the region when the photographed image is one that is photographed from the projection plane onto which the image is projected after the correction of distortion of the shape and there exists a region including the partial image whose size becomes large compared with the partial image before the correction among the regions in the photographed image.

15. The semiconductor integrated circuit according to claim 11, wherein the projection plane has an uneven surface, and wherein the correction part generates the first corrected image so that the resolutions among the regions may become uniform according to the uneven surface.
